(19) United States
(12) Patent Application Publication
(10) Pub. No.: US 2025/0090962 A1
(43) Pub. Date: Mar. 20, 2025

(54) NON-TRANSITORY COMPUTER READABLE MEDIUM, INFORMATION PROCESSING METHOD, AND GAME DEVICE

(71) Applicant: CYGAMES, INC., Tokyo (JP)

(72) Inventors: Koichi Kada, Tokyo (JP); Yuki Tamura, Tokyo (JP); Yujiro Deguchi, Tokyo (JP)

(73) Assignee: CYGAMES, INC., Tokyo (JP)

(21) Appl. No.: 18/970,250

(22) Filed: Dec. 5, 2024

Related U.S. Application Data
(63) Continuation of application No. PCT/JP2023/018997, filed on May 22, 2023.

(30) Foreign Application Priority Data
Jun. 15, 2022 (JP) 2022-096183

(51) Int. Cl. A63F 13/69; A63F 13/45; A63F 13/53; A63F 13/825

(52) U.S. Cl. CPC A63F 13/69; A63F 13/45; A63F 13/53; A63F 13/825

(57) ABSTRACT

A non-transitory computer readable medium stores a program causing a computer to execute: enabling a player to select a plurality of commands including first and second commands in a preset turn in a nurture game; obtaining a predetermined parameter based on the fact that the first command has been selected; enabling the player to obtain at least a part of a plurality of rewards bringing benefits advantageous to the player by consuming the predetermined parameter based on the fact that the second command has been selected; determining a plurality of rewards newly obtainable for the player based on the fact that said reward has been obtained by the player; making one or more benefits corresponding to said reward obtained by the player occur at a predetermined timing; and ending the currently executed turn and making a transition to a next turn when a preset turn end condition is established.

### CROSS REFERENCE TO RELATED APPLICATIONS

This application is a continuation application of International Application No. PCT/JP2023/018997, filed on May 22, 2023, which claims priority to Japanese Patent Application No. 2022-096183, filed on Jun. 15, 2022, the entire contents of which are incorporated by reference herein.

### BACKGROUND ART

### Technical Field

The present invention relates to an information processing program, an information processing method, and a game device.

In the related art, there is a known nurture game in which a player nurtures a character, as shown in Patent Literature 1, for example. In the nurture game shown in Patent Literature 1, a player can obtain various rewards when the game progresses.

### CITATION LIST

### Patent Literature

Patent Literature 1: JP 2021-121396 A

### SUMMARY OF INVENTION

### Technical Problem

In the above-described nurture game, the abilities of a nurture-target character change depending on what rewards the player obtains. However, in conventional nurture games, there is no big difference in the method for obtaining rewards, and a new game property is desired.

The purpose of the present invention is to provide an information processing program, an information processing method, and a game device capable of improving player's motivation to play a game due to a new game property.

### Solution to Problem

In order to achieve the above-described purpose, the present invention provides an information processing program causing a computer to carry out a nurture game that includes a plurality of turns, the information processing program causing the computer to carry out: processing for enabling a player to select a plurality of commands including at least a first type command and a second type command, in a preset turn of the turns; processing for obtaining a predetermined parameter on the basis of the fact that the first type command has been selected; processing for enabling the player to obtain at least a part of a plurality of rewards that bring benefits advantageous to the player, by consuming the predetermined parameter, on the basis of the fact that the second type command has been selected; processing for determining a plurality of rewards that can be newly obtained by the player, on the basis of the fact that said reward has been obtained by the player; processing for making benefits that correspond to said reward obtained by the player, occur at a predetermined timing; and processing for ending the currently executed turn and making a transition to the next turn, when a preset turn end condition including at least that the first type command has been selected is established.

Furthermore, the benefits may include: a first benefit that occurs in the turn in which the player obtains; and a second benefit that occurs in a preset particular turn after the turn in which the player obtains.

Furthermore, in the processing for enabling the player to obtain said reward, the plurality of rewards that can be obtained by the player may be individually displayed in reward display fields in an identifiable manner, and the reward display fields may each include a first display region in which the first benefit is displayed and a second display region in which the second benefit is displayed.

Furthermore, the benefits may be classified into a first benefit and a second benefit; in the processing for enabling the player to obtain said reward, the plurality of rewards that can be obtained by the player may be individually displayed in reward display fields in an identifiable manner; and the reward display fields may each include a first display region in which the first benefit is displayed and a second display region in which the second benefit is displayed.

In the processing for determining a plurality of rewards that can be newly obtained by the player, the plurality of rewards that can be newly obtained by the player may be determined on the basis of reward route information in which relations between said reward obtained by the player and the plurality of rewards that can be newly obtained by the player are defined in advance.

In the processing for determining a plurality of rewards that can be newly obtained by the player, the plurality of rewards that can be newly obtained by the player may be determined by a lottery.

In order to achieve the above-described purpose, the present invention provides an information processing method in which one or a plurality of computers carry out a nurture game including a plurality of turns, the one or a plurality of computers carrying out: processing for enabling a player to select a plurality of commands including at least a first type command and a second type command, in a preset turn of the turns; processing for obtaining a predetermined parameter on the basis of the fact that the first type command has been selected; processing for enabling the player to obtain at least a part of a plurality of rewards that bring benefits advantageous to the player, by consuming the predetermined parameter, on the basis of the fact that the second type command has been selected; processing for determining a plurality of rewards that can be newly obtained by the player, on the basis of the fact that said reward has been obtained by the player; processing for making benefits that correspond to said reward obtained by the player, occur at a predetermined timing; and processing for ending the currently executed turn and making a transition to the next turn, when a preset turn end condition including at least that the first type command has been selected is established.

In order to achieve the above-described purpose, the present invention provides a game device that includes one or a plurality of computers carrying out a nurture game including a plurality of turns, the one or a plurality of computers carrying out: processing for enabling a player to select a plurality of commands including at least a first type command and a second type command, in a preset turn of the turns; processing for obtaining a predetermined parameter on the basis of the fact that the first type command has been selected; processing for enabling the player to obtain at least a part of a plurality of rewards that bring benefits advantageous to the player, by consuming the predetermined parameter, on the basis of the fact that the second type command has been selected; processing for determining a plurality of rewards that can be newly obtained by the player, on the basis of the fact that said reward has been obtained by the player; processing for making benefits that correspond to said reward obtained by the player, occur at a predetermined timing; and processing for ending the currently executed turn and making a transition to the next turn, when a preset turn end condition including at least that the first type command has been selected is established.

### Effects of Disclosure

According to the present invention, it is possible to improve player's motivation to play a game due to a new game property.

### BRIEF DESCRIPTION OF DRAWINGS

FIG. 1 is an explanatory view showing, in outline, the configuration of an information processing system.

FIG. 2A is a view for explaining the hardware configuration of a player terminal. FIG. 2B is a view for explaining the hardware configuration of a server.

FIG. 3A is a view for explaining an example of a home screen. FIG. 3B is a view for explaining an example of an option setting screen. FIG. 3C is a view for explaining an example of a profile setting screen. FIG. 3D is a view for explaining an example of a home setting screen.

FIG. 4 is a view for explaining a rough flow of progress of a nurture game.

FIG. 5A is a view for explaining a nurture-target-character selection screen. FIG. 5B is a first view for explaining a character detail screen. FIG. 5C is a second view for explaining the character detail screen.

FIG. 6A is a view for explaining an ability parameter (initial value) table. FIG. 6B is a view for explaining an aptitude parameter (initial value) table. FIG. 6C is a view for explaining a skill table. FIG. 6D is a view for explaining a dedicated-event table.

FIG. 7A is a first view for explaining an inheritance character selection screen. FIG. 7B is a first view for explaining a nurtured-character list screen. FIG. 7C is a second view for explaining the inheritance character selection screen. FIG. 7D is a third view for explaining the inheritance character selection screen.

FIG. 8 is a view for explaining lineage of inheritance.

FIG. 9 is a view for explaining factor information.

FIG. 10A is a view for explaining compatibility judgment targets. FIG. 10B is a view for explaining compatibility judgment items.

FIG. 11A is a view for explaining a sort condition. FIG. 11B is a view for explaining a filtering condition.

FIG. 12 is a first view for explaining a character detail dialog.

FIG. 13 is a second view for explaining the character detail dialog.

FIG. 14 is a third view for explaining the character detail dialog.

FIG. 15 is a view for explaining a skill display dialog.

FIG. 16A is a first view for explaining a support-card organization screen. FIG. 16B is a view for explaining a support-card selection screen. FIG. 16C is a second view for explaining the support-card organization screen.

FIG. 17A is a view for explaining a support card table.

FIG. 17B is a view for explaining a support effect table.

FIG. 17C is a view for explaining a possessed-skill table.

FIG. 17D is a view for explaining a support event table.

FIG. 18A is a view for explaining a final confirmation screen. FIG. 18B is a view for explaining a preset selection screen.

FIG. 19 is a view for explaining selection items in each turn.

FIG. 20 is a view for explaining a game screen.

FIG. 21A is a first view for explaining a training screen. FIG. 21B is a second view for explaining the training screen. FIG. 21C is a view for explaining a training-result notification screen. FIG. 21D is a view for explaining an event screen.

FIG. 22A is a first view for explaining a skill screen.

FIG. 22B is a second view for explaining the skill screen.

FIG. 23A is a first view for explaining a race selection screen. FIG. 23B is a view for explaining a race start screen. FIG. 23C is a first view for explaining a race result screen. FIG. 23D is a second view for explaining the race result screen.

FIG. 24A is a view for explaining an example of a live preparation screen. FIG. 24B is a view for explaining a confirmation dialog.

FIG. 25 is a view for explaining examples of a first bonus and a second bonus.

FIG. 26 is a view for explaining an example of live-song route information.

FIG. 27A is a view for explaining an example of a live start screen. FIG. 27B is a view for explaining an example of a live event screen.

FIG. 28 is a view for explaining a rough flow of turn start-time processing.

FIG. 29 is a view for explaining an arrangement-or-not table.

FIG. 30A is a view for explaining a training-level table.

FIG. 30B is a view for explaining an increase fixed value (speed) table. Furthermore, FIG. 30C is a view for explaining an increase fixed value table (power). FIG. 30D is a view for explaining a bonus addition rate table.

FIG. 31A is a view for explaining performance items linked to training items. FIG. 31B is a view for explaining increase fixed values for performance parameters. FIG. 31C is a view for explaining bonus addition rates for performance parameters.

FIG. 32 is a view for explaining a second-event table.

FIG. 33A is a view for explaining a nurture complete screen. FIG. 33B is a second view for explaining the nurture complete screen. FIG. 33C is a third view for explaining the nurture complete screen.

FIG. 34 is a view for explaining the configuration of a memory at the player terminal and the function of the player terminal serving as a computer.

FIG. 35 is a view for explaining the configuration of a memory at the server and the function of the server serving as a computer.

FIG. 36 is a sequence diagram for explaining processing procedures related to the nurture game and performed at the player terminal and the server.

FIG. 37 is a flowchart for explaining nurture-stage processing at the server.

FIG. 38 is a flowchart for explaining turn start-time processing at the server.

FIG. 39 is a flowchart for explaining nurture-stage processing at the player terminal.

FIG. 40 is a flowchart for explaining turn start-time processing at the player terminal.

FIG. 41 is a flowchart for explaining middle-of-turn processing at the player terminal.

FIG. 42 is a flowchart for explaining command selection processing at the player terminal.

FIG. 43 is a first flowchart for explaining middle-of-turn processing at the server.

FIG. 44 is a second flowchart for explaining the middle-of-turn processing at the server.

FIG. 45 is a flowchart for explaining command receiving processing at the player terminal.

### DESCRIPTION OF EMBODIMENT

One aspect of an embodiment of the present invention will be described in detail below with reference to the accompanying drawings. Numerical values and the like shown in the embodiment are merely examples for facilitating understanding and do not limit the present invention unless otherwise specified. In the present specification and drawings, elements having substantially the same function and configuration are given the same reference numerals to omit redundant description, and elements that are not directly related to the present invention are omitted from the drawings.

### (Overall Configuration of Information Processing System S)

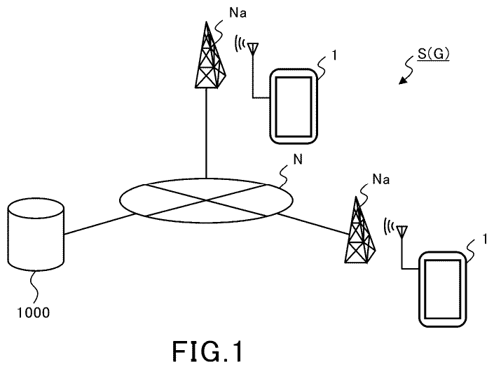

FIG. 1 is an explanatory view showing, in outline, the configuration of an information processing system S. The information processing system S is a so-called client-server system that includes: player terminals 1 functioning as clients, i.e., game terminals; a server 1000; and a communication network N having communication base stations Na.

In the information processing system S according to this embodiment, each of the player terminals 1 and the server 1000 function as a game device G. The player terminal 1 and the server 1000 respectively play roles for controlling the proceeding of a game, whereby it is possible to proceed with the game through cooperation between the player terminal 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include, for example, smartphones, mobile phones, tablet devices, personal computers, game machines, or the like. In this embodiment, a description will be given of a case in which smartphones are used as the player terminals 1.

The server 1000 is communicatively connected to the plurality of player terminals 1. The server 1000 accumulates various kinds of information, for each player who plays a game. Furthermore, the server 1000 mainly updates the accumulated information and performs processing for allowing each of the player terminals 1 to download images and various kinds of information, on the basis of operations input from the player terminal 1.

The communication base stations Na are connected to the communication network N and send information to and receive information from the player terminals 1 wirelessly. The communication network N is configured of a mobile-phone network, an Internet network, a local area network (LAN), a dedicated line, or the like, to realize wireless or wired communication connection between the player terminals 1 and the server 1000.

### (Hardware Configurations of Player Terminal 1 and Server 1000)

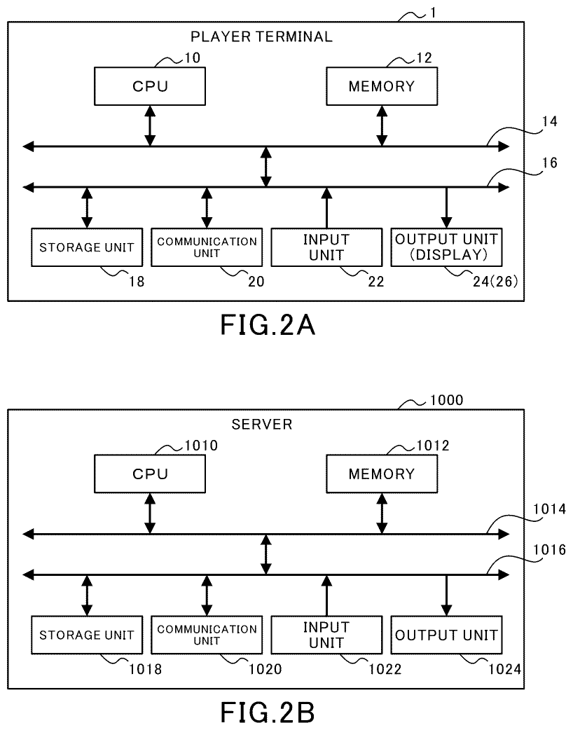

FIG. 2A is a diagram for explaining the hardware configuration of the player terminal 1. Furthermore, FIG. 2B is a diagram for explaining the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and the functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24 of the player terminal 1, respectively. Therefore, the hardware configuration of the player terminal 1 will be described below, and a description of the server 1000 is omitted.

The CPU 10 runs a program stored in the memory 12 to control the proceeding of the game. The memory 12 is configured of a read only memory (ROM) or a random access memory (RAN) and stores programs and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to the communication base station Na wirelessly, and sends information to and receives information from the server 1000 via the communication network N, such as various kinds of data and programs. At the player terminal 1, the programs etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a dedicated controller provided in the player terminal 1 or connected (externally attached) to the player terminal 1. Alternatively, the input unit 22 may be configured of an acceleration sensor that detects tilting or movement of the player terminal 1 or a microphone that detects speech of the player. That is, the input unit 22 may widely include devices that enable the player to input his or her intents in distinguishable manners.

The output unit 24 is configured to include a display device and a speaker. Note that the output unit 24 may be a device connected (externally attached) to the player terminal 1. In this embodiment, the player terminal 1 includes a display 26 as the output unit 24 and includes, as the input unit 22, a touchscreen provided in the display 26 so as to be overlaid thereon.

### (Game Content)

Next, a game provided by the information processing system S, the game device G, of this embodiment will be described. A player can possess a character obtained by a lottery called gacha and a character distributed by a management side. Furthermore, the player can possess a support card obtained by the lottery and a support card distributed by the management side.

Although a detailed description will be given later, in the game according to this embodiment, a nurture game is provided. The player can nurture a character possessed by the player in the nurture game. Furthermore, the nurture game in this embodiment has a game property in which a character is nurtured while being made to participate in a race simulating a horse race.

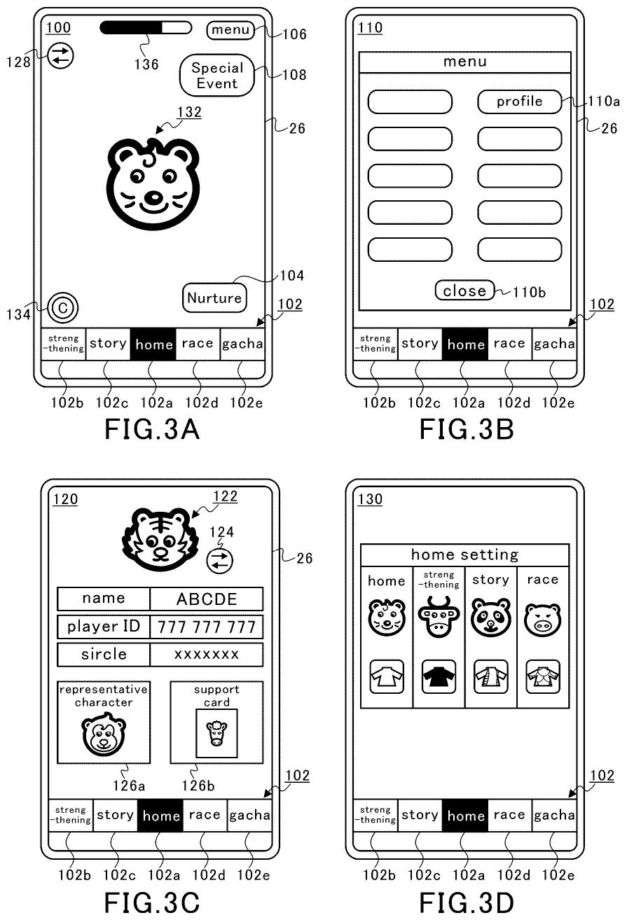

FIG. 3A is a view for explaining an example of a home screen 100. When a game application is activated at the player terminal 1, the home screen 100 is displayed on the display 26. A menu bar 102 is displayed at a lower section of the home screen 100. In the menu bar 102, a plurality of operation sections that can be operated (tapped) by the player are provided.

Here, in the menu bar 102, a home-screen selection operation section 102a, a strengthening-screen selection operation section 102b, a story-screen selection operation section 102c, a race-game selection operation section 102d, and a gacha-screen selection operation section 102e are provided. Note that, in order to be able to identify the screen currently displayed on the display 26, the operation section corresponding to the currently displayed screen is highlighted in the menu bar 102.

When the home-screen selection operation section 102a is tapped, the home screen 100, which is shown in FIG. 3A, is displayed on the display 26.

When the strengthening-screen selection operation section 102b is tapped, a strengthening screen (not shown) is displayed. In the strengthening screen, it is possible to strengthen characters or support cards possessed by the player. The player strengthens the characters or the support cards, thereby making it possible to raise the levels set for the characters or the support cards. Various parameters are set for the characters and the support cards and are increased when the levels thereof are raised. When the parameters of the characters and the support cards are increased, the player can nurture a character having a more powerful status in the nurture game.

When the story-screen selection operation section 102c is tapped, a story screen (not shown) is displayed. Here, a story image is provided for each character that appears in the game. The player can select and view a character and the story image thereof in the story screen.

When the race-game selection operation section 102d is tapped, a race-game selection screen (not shown) is displayed. In this embodiment, various race games are provided, in which a nurtured character nurtured in a nurture game, to be described later, can be made to participate. In the race-game selection screen, the player can select a race game in which the nurtured character is made to participate. Examples of the race games include a team competition game in which a team organized by a plurality of nurtured characters and a team of another player selected by a computer are made to compete with each other. The team competition game has a game property to compete with the other player for ranking.

When the gacha-screen selection operation section 102e is tapped, a gacha screen (not shown) is displayed. In the gacha screen, the player can perform a so-called gacha lottery in which a character or a support card can be obtained by a lottery, by consuming in-game currency.

Furthermore, in the home screen 100, a nurture-game operation section 104 is provided above the menu bar 102. When the nurture-game operation section 104 is tapped, a nurture-game screen is displayed, and the nurture game, to be described later, is started. The nurture game is roughly divided into a preparatory stage and a nurture stage. First, in the preparatory stage, the player selects one character from among characters possessed by the player and sets the character as a character to be nurtured (hereinafter, referred to as a nurture-target character).

Furthermore, in the preparatory stage, the player sets a deck to be used when the nurture-target character is nurtured. The deck is organized by a plurality of inheritance characters and a plurality of support cards, to be described in detail later. Therefore, the inheritance characters and the support cards organized in the deck are used in the nurture game.

When the settings of the nurture-target character and the deck (the inheritance characters and the support cards) are completed, the stage is transitioned from the preparatory stage to the nurture stage, and the game for nurturing the nurture-target character is started. In the nurture game, the parameters of the nurture-target character can be changed. The player can possess characters that have been nurtured in the nurture game, as nurtured characters. As described above, the player can organize possessed nurtured characters in a team and use the team in the team competition game or the like.

In this way, a main purpose of the game of this embodiment is to nurture a nurtured character in the nurture game and to increase the ranking in the team competition game by using nurtured characters.

Furthermore, in this embodiment, a function of sharing a nurtured character or a support card between players and a function of sharing information between a plurality of players are provided. The player can set a nurtured character and a support card that can be used by another player in the nurture game. Specifically, as shown in FIG. 3A, a setting operation section 106 is provided at an upper right section of the home screen 100. When the setting operation section 106 is tapped, an option setting screen 110 is displayed.

FIG. 3B is a view for explaining an example of the option setting screen 110. The option setting screen 110 is a screen in which various kinds of information can be confirmed and set. In the option setting screen 110, a plurality of operation sections are provided, and, when any of the operation sections is tapped, information corresponding to the operation section can be confirmed and set.

The operation sections in the option setting screen 110 include a profile-setting operation section 110a and a close operation section 110b. When the close operation section 110b is tapped, the option setting screen 110 is closed, and the home screen 100 is displayed. When the profile-setting operation section 110a is tapped, a profile setting screen 120 is displayed.

FIG. 3C is a view for explaining an example of the profile setting screen 120. In the profile setting screen 120, the player can confirm and set his or her own profile information. The profile information includes a profile character, a player name, a player ID, an affiliated circle, a representative character, and a rental card.

The profile character functions as a character to be displayed when the information of the player is viewed by another player(s). For example, the profile character is displayed when a circle function that serves as a place to share information with the other player(s) is used. In the profile setting screen 120, a profile character image 122 that is currently set is displayed. A change button 124 is provided near the profile character image 122. When the change button 124 is tapped, a profile-character change screen (not shown) is displayed. The player can change the profile character in the profile-character change screen.

Furthermore, in the profile setting screen 120, the player name set by the player, the player ID assigned to the player, and the name of the circle to which the player belongs are displayed. Furthermore, a representative-character setting operation section 126a and a rental-card setting operation section 126b are provided in the profile setting screen 120.

When the representative-character setting operation section 126a is tapped, a representative-character setting screen (not shown) is displayed. In the representative-character setting screen, the player can set, as a representative character, any one of the nurtured characters that have been nurtured by the player himself/herself. In the representative-character setting operation section 126a, an icon image showing the currently set representative character is displayed. Note that, although a detailed description will be given later, the representative character can be organized, as an inheritance character, into a deck in a nurture game played by another player.

When the rental-card setting operation section 126b is tapped, a rental-card setting screen (not shown) is displayed. In the rental-card setting screen, the player can set, as a rental card, any one of the support cards possessed by the player himself/herself. In the rental-card setting operation section 126b, an icon image showing the currently set rental card is displayed. Note that, as described above, the support card that is set as a rental card can be organized into a deck by another player and is used in a nurture game played by the other player.

Note that, although a detailed description is omitted, when the setting of the profile information is changed in the profile setting screen 120, setting change information is sent to the server 1000. At the server 1000, the profile information is stored for each player.

Furthermore, as shown in FIG. 3A, a setting icon 128 is displayed in the home screen 100. When the setting icon 128 is tapped, a home setting screen 130 is displayed.

FIG. 3D is a view for explaining an example of the home setting screen 130. In the home setting screen 130, the player can set a home-screen setting character(s) 132 to be displayed in the home screen 100. The player can set four home-screen setting characters 132 to be displayed in the home screen 100.

Although not shown in the figures, when a flick operation in the horizontal direction is input in the home screen 100, the screen displayed on the display 26, i.e., the display in the home screen 100, is switched. In the home screen 100, the currently set four home-screen setting characters 132 are displayed. Functions serving as the individual operation sections displayed in the menu bar 102 are assigned to the home-screen setting characters 132. Therefore, when any of the home-screen setting characters 132 displayed in the home screen 100 is tapped, the screen is switched in the same way as when any of the operation sections in the menu bar 102 is tapped.

In the home setting screen 130, character images corresponding to the currently set four home-screen setting characters 132 and operation sections corresponding thereto are displayed in an identifiable manner. When any of the character images displayed in the home setting screen 130 is tapped, a character selection screen (not shown) is displayed. The player can select the home-screen setting character 132 in the character selection screen. Furthermore, the player can set a costume for the home-screen setting character 132 in the home setting screen 130.

Furthermore, as shown in FIG. 3A, a circle icon 134 is displayed in the home screen 100. When the circle icon 134 is tapped, a circle screen is displayed. In the circle screen, the player can exchange information with another player who belongs to the same circle.

Furthermore, in this embodiment, various limited-time events are held irregularly. During the period of a specific event that is one of the limited-time events, a specific-event icon 108 is displayed in the home screen 100. When the specific-event icon 108 is tapped, a specific-event screen is displayed. In the specific-event screen, the player can exchange specific-event points provided only by the specific event, for various rewards, for example.

In the home screen 100, when the nurture-game operation section 104 is tapped, the nurture-game screen is displayed, and the nurture game is started. Note that the player can play the nurture game by consuming game points. The game points are given to the player by a predetermined value (for example, +1) at intervals of a predetermined period of time (for example, ten minutes). The game points that can be possessed by the player have an upper limit (for example, 100) set therefor, and the player can possess the game points within the range defined by the upper limit. A game-point display bar 136 is provided at an upper section of the home screen 100, and the percentage of the currently possessed game points with respect to the upper limit is visually displayed.

Note that a predetermined value (for example, −30) is subtracted from the game points when the nurture game is started. Therefore, if the player does not possess the required game points, the player cannot start the nurture game. However, the player can possess an item for restoring the game points and can restore the game points by using the item. This item can be given, for example, as a reward for the nurture game or the team competition game or can be obtained by consuming the in-game currency. The nurture game will be described in detail below.

### (Nurture Game)

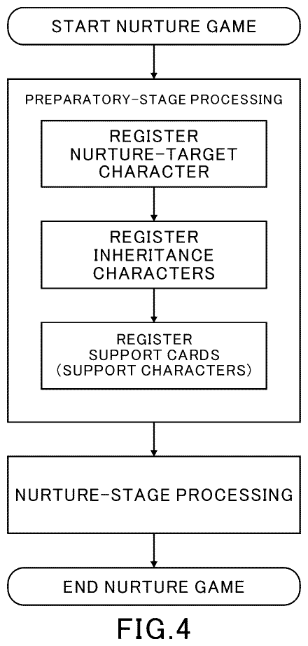

FIG. 4 is a view for explaining a rough flow of the nurture game. The nurture game is roughly divided into a setting game and a nurture main game. Although a detailed description will be given later, the nurture main game is a game in which one nurture-target character selected from among the characters possessed by the player is nurtured as a nurture-target character.

Furthermore, the setting game is a game in which the player registers a nurture-target character and a deck (inheritance characters and support cards), and corresponds to the preparatory stage of the nurture game. Hereinafter, processing to be carried out in the setting game is referred to as preparatory-stage processing, and processing to be carried out in the nurture main game is referred to as nurture-stage processing. Here, in order to facilitate understanding, rough flows of the preparatory-stage processing and the nurture-stage processing will be described first.

### <Preparatory-Stage Processing>

In the preparatory-stage processing, registration of a nurture-target character and registration of a deck (inheritance characters and support cards) are mainly performed. Note that support cards are used to support the nurture of a nurture-target character. Each of the support cards is surely linked to one character, and the characters linked to the support cards registered in the preparatory-stage processing support the nurture of the nurture-target character. Hereinafter, the characters linked to the support cards are referred to as support characters.

### <Registration of Nurture-Target Character>

In the home screen 100, when the nurture-game operation section 104 is tapped by the player, a scenario selection screen (not shown) is displayed. In this embodiment, a plurality of scenarios for the nurture main game are provided. In the respective scenarios for the nurture main game, the final goals, goals in the middle of the game, etc., have been set, and the player needs to sequentially clear the set goals. The respective goals and periods of time during which the goals are achieved are different for each scenario. The player can select one from among the plurality of scenarios in the scenario selection screen. Here, a description will be given of a case in which a predetermined scenario is selected.

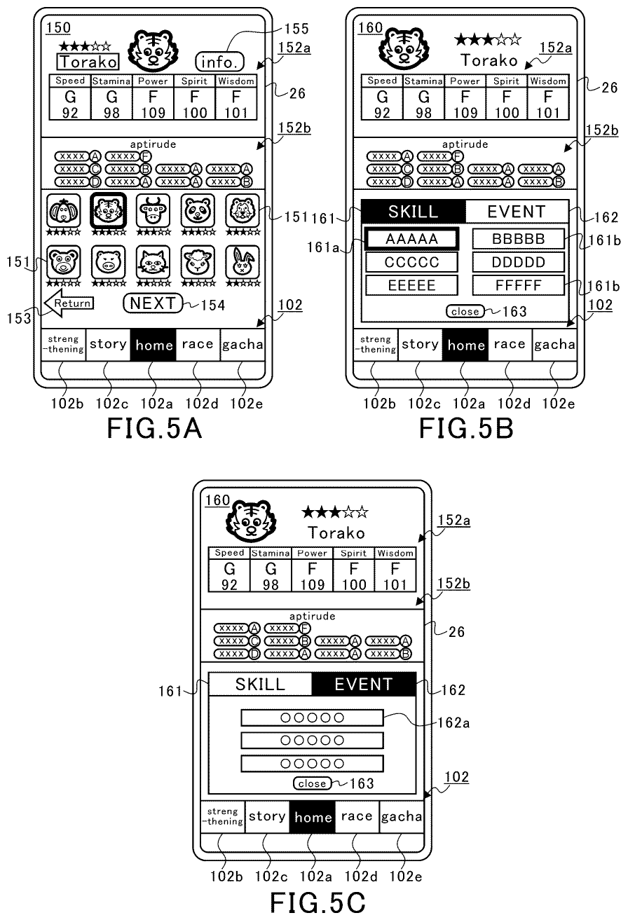

FIG. 5A is a view for explaining a nurture-target character selection screen 150. At a central section of the nurture-target character selection screen 150, a plurality of character icons 151 are displayed, and the characters possessed by the player are displayed in a list. Furthermore, an ability-parameter display section 152a and an aptitude-parameter display section 152b are displayed at an upper section of the nurture-target character selection screen 150. Furthermore, a return operation section 153, in which “Return” is written, and a next operation section 154, in which “NEXT” is written, are displayed at a lower section of the nurture-target character selection screen 150.

In this embodiment, the initial values of the ability parameters are set for each character, and the initial values of the ability parameters of the character corresponding to a character icon 151 selected by the player are numerically displayed in the ability-parameter display section 152a. In this embodiment, it is indicated that the abilities are higher as the values of the ability parameters are increased.

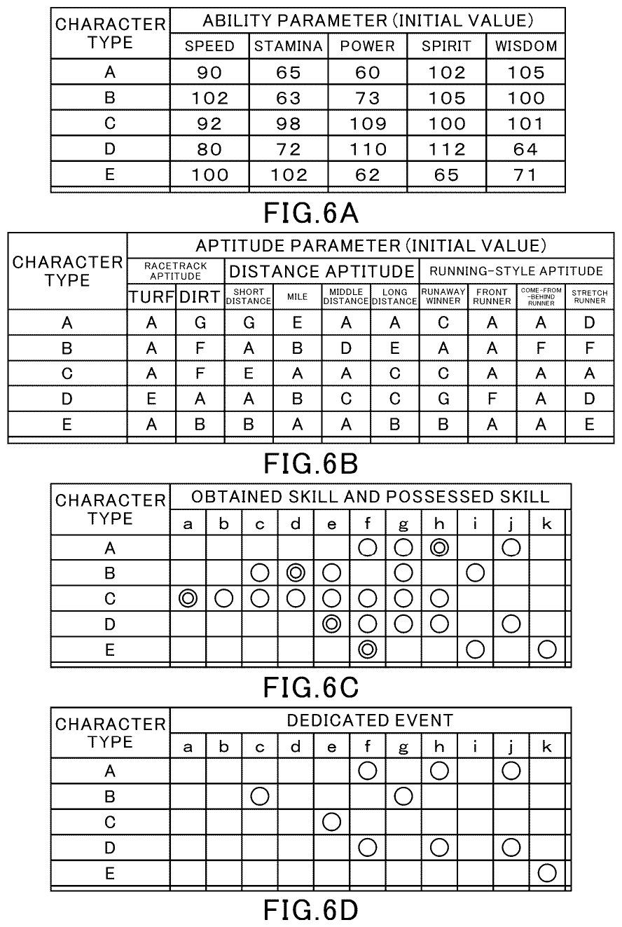

FIG. 6A is a view for explaining an ability parameter (initial value) table. In this embodiment, as shown in FIG. 6A, the initial values of the ability parameters of each character are stored in the ability parameter (initial value) table. Then, the initial values of the ability parameters are displayed in the ability-parameter display section 152a on the basis of the initial values of the ability parameters stored in the ability parameter (initial value) table.

In this embodiment, the initial values of the ability parameters are set for a plurality of kinds of abilities for each character. Specifically, a speed ability parameter, in which “Speed” is written in the ability-parameter display section 152a, a stamina ability parameter, in which “Stamina” is written in the ability-parameter display section 152a, a power ability parameter, in which “Power” is written in the ability-parameter display section 152a, a spirit ability parameter, in which “Spirit” is written in the ability-parameter display section 152a, and a wisdom ability parameter, in which “Wisdom” is written in the ability-parameter display section 152a, are provided as the ability parameters.

Note that the initial values of the ability parameters of each character are increased by a player's operation etc. For example, five status levels are provided for each character, and the player can raise the status level of the character by consuming the in-game currency or a predetermined item. When the status level of the character is raised, the initial values of the ability parameters of the character are increased. FIG. 6A shows the initial values when characters are at a predetermined level. Note that the player can increase the values of the ability parameters in the nurture main game. That is, the purpose of the nurture main game is to nurture a character having higher values of the ability parameters.

Furthermore, in this embodiment, aptitude parameters (initial values) are set for each character. As shown in FIG. 5A, the initial values of the aptitude parameters of the character corresponding to the character icon 151 selected by the player are displayed with alphabets in the aptitude-parameter display section 152b.

FIG. 6B is a view for explaining an aptitude parameter (initial value) table. In this embodiment, as shown in FIG. 6B, the initial values of the aptitude parameters of each character are stored in the aptitude parameter (initial value) table. The initial values of the aptitude parameters are each set to any of seven stages with alphabets A to G. Note that, in the initial values of the aptitude parameters, A indicates the highest aptitude, and G indicates the lowest aptitude. The initial values of the aptitude parameters are displayed in the aptitude-parameter display section 152b on the basis of the initial values of the aptitude parameters stored in the aptitude parameter (initial value) table.

In this embodiment, the initial values of the aptitude parameters are set for a plurality of kinds of aptitudes for each character. Specifically, provided as the aptitude parameters are: aptitude parameters related to racetrack aptitudes of turf and dirt; aptitude parameters related to distance aptitudes of short distance, mile, middle distance, and long distance; and aptitude parameters related to running-style aptitudes of runaway winner, front runner, come-from-behind runner, and stretch runner.

In the nurture game, the player can make the nurture-target character participate in various races. At this time, the race development becomes advantageous as the aptitudes of the nurture-target character that are suitable for the race content are higher.

Note that it is also possible that the initial values of the aptitude parameters of each character are increased by consuming the in-game currency. Furthermore, the values of the aptitude parameters may be changed in the nurture main game. Furthermore, in the nurture main game, the aptitude parameter(s) may also be set to S that indicates a higher aptitude than A.

FIG. 5B is a first view for explaining a character detail screen 160. Furthermore, FIG. 5C is a second view for explaining the character detail screen 160. When any of the character icons 151 in the nurture-target character selection screen 150 is pressed and held, the character detail screen 160 is displayed on the display 26. In the character detail screen 160, the details of the abilities of the character corresponding to the character icon 151 pressed and held in the nurture-target character selection screen 150 are displayed.

A skill operation section 161 and an event operation section 162 are displayed at a central section of the character detail screen 160. As shown in FIG. 5B, when the character detail screen 160 is first displayed, the skill operation section 161 is highlighted, and skills provided for each character are displayed. The skills are each an ability that can be activated when a predetermined condition is established during execution of a race, to be described later. The race development of each character becomes advantageous through activation of a skill thereof.

FIG. 6C is a view for explaining a skill table. As shown in FIG. 6C, skills of each of the characters possessed by the player are stored in the skill table. Then, as shown in FIG. 5B, skills are displayed in the character detail screen 160 on the basis of the skills stored in the skill table. Note that the skills are not activated just by being possessed but can be activated only after being obtained. Hereinafter, a skill that can be activated by the character is referred to as an obtained skill.

One obtained skill is set for each character at the beginning of start of the nurture main game. Furthermore, a plurality of possessed skills are set for each character, separately from the obtained skill. The possessed skills are skills that can be obtained by consuming skill points, to be described later, after the start of the nurture main game. Thus, the possessed skills can be obtained skills in exchange for the skill points.

In this embodiment, a skill corresponding to “a double circle” in the skill table, which is shown in FIG. 6C, is displayed as an obtained skill in the character detail screen 160, which is shown in FIG. 5B. Furthermore, skills corresponding to “a single circle” in the skill table, which is shown in FIG. 6C, are displayed as possessed skills in the character detail screen 160, which is shown in FIG. 5B. In this embodiment, in order to make it easier to distinguish between the obtained skill and the possessed skills, the obtained skill is highlighted, as shown in the character detail screen 160 of FIG. 5B.

Note that, although FIG. 5B shows a case in which, as the skills set for each character, one obtained skill is displayed in an obtained-skill display field 161a, and seven possessed skills are displayed in possessed-skill display fields 161b, the present invention is not limited thereto. For example, a different number of obtained skills and a different number of possessed skills may be set for each character. Furthermore, the number of obtained skills or the number of possessed skills for each character may be increased due to a raise in the level of the character or consumption of the in-game currency or an item, for example.

Furthermore, when the player taps the event operation section 162 in the character detail screen 160, the content in the character detail screen 160 is switched, and a dedicated-event display field(s) 162a that shows a dedicated event(s) provided for each character is displayed, as shown in FIG. 5C. In this case, the event operation section 162 is highlighted, as shown in FIG. 5C. A dedicated event is an event that occurs when a predetermined condition is established during the nurture main game, for displaying a story related to a character appearing in the nurture game or for changing the values of the ability parameters.

FIG. 6D is a view for explaining a dedicated-event table. As shown in FIG. 6D, in the dedicated-event table, a dedicated event(s) is stored for each of the characters possessed by the player. Then, dedicated events are displayed in the character detail screen 160, as shown in FIG. 5C, on the basis of the dedicated events stored in the dedicated-event table. Note that examples of the dedicated events may include a tip event for allowing a skill to be possessed or obtained, an ability event for increasing or decreasing the values of the ability parameters of the character, etc.

Note that the dedicated events displayed in the character detail screen 160 shown in FIG. 5C may be all executed during the execution of the nurture main game, at least some of them may be executed during the execution of the nurture main game, or none of them may be executed during the execution of the nurture main game if the predetermined condition is not established. Furthermore, for example, the number of dedicated events provided for each character may be increased due to a raise in the level of the character or consumption of the in-game currency or an item. Furthermore, in the case where the predetermined condition is established, a dedicated event that is not displayed as a dedicated event may be executed during the nurture main game.

Furthermore, as shown in FIGS. 5B and 5C, a close operation section 163, in which “close” is written, is displayed at a lower section of the character detail screen 160. When the close operation section 163 in the character detail screen 160 is tapped, the display of the character detail screen 160 is ended, and the nurture-target character selection screen 150 is displayed on the display 26.

Furthermore, when the return operation section 153 is tapped in the nurture-target character selection screen 150, which is shown in FIG. 5A, the home screen 100, which is shown in FIG. 3A, is displayed on the display 26. Furthermore, a nurture information display button 155 is provided in the nurture-target character selection screen 150. When the nurture information display button 155 is tapped, a nurture information display screen (not shown) is displayed. The player can confirm information related to the character selected in the nurture-target character selection screen 150, in the nurture information display screen.

In the nurture information display screen, a clear goal tab is provided. Here, the purpose of the nurture game is to nurture a character selected, from among the characters possessed by the player, as a nurture-target character, thereby generating a stronger nurtured character. Although a detailed description will be given later, the nurture main game is composed of a plurality of turns, and the player is required to give training to the nurture-target character or to make the nurture-target character participate in a race, in each turn.

Then, a plurality of clear goals are set for each character. When the clear goal tab is tapped, clear goals that are set for the selected character are displayed in a list in the nurture information display screen. In each turn, a race(s) in which the nurture-target character can be made to participate is set in advance.

Furthermore, when the nurture-target character is made to participate in a race, the nurture-target character can obtain fans, victory points, and special currency. In each race, the base acquisition counts of fans, victory points, and special currency are set for individual orders of arrival, and the values of fans, victory points, and special currency to be obtained are increased as the order of arrival is higher. Furthermore, the difficulty level is set for a race, and more fans, more victory points, and more special currency can be obtained as a higher difficulty level is set for the race. For example, among races, races of grades of GI, GII, and GIII, called major prize, are provided. The grade becomes higher in the order of GIII, GII, and GI. As a higher grade is set for a race, the difficulty level becomes higher, and more fans, more victory points, and more special currency can be obtained.

Here, the number of fans that can be obtained due to participation in a race is calculated by adding the bonus acquisition count to the base acquisition count, which is set for individual orders of arrival. Specifically, a correction value is determined on the basis of a race result, and the base acquisition count is multiplied by the correction value, thereby calculating the bonus acquisition count. The total of the bonus acquisition count and the base acquisition count is the number of fans to be obtained by the nurture-target character. For example, in the case where the race result is the 1st place, the correction value becomes larger as the difference between the nurture-target character and the 2nd-place character is increased. Furthermore, in the case where the race result falls within the range from the 2nd place to the 5th place, the correction value becomes larger as the difference between the nurture-target character and the 1st-place character is reduced.

Furthermore, the nurture-target character activates a skill at a predetermined rate during a race. At this time, the correction value becomes larger as the number of activated skills is increased. In this way, in each race, an addition condition for the number of fans is set, and the number of fans to be obtained is increased depending on various race results other than the order of arrival and the progress during the race. However, the number of fans to be obtained by the nurture-target character is at least the base acquisition count corresponding to the order of arrival.

Note that, in some races, the number of fans is prescribed as a participation condition. In the case where the number of fans that have been obtained by the nurture-target character is less than the number of fans prescribed as the participation condition, the player cannot make the nurture-target character participate in that race. As the difficulty level of a race becomes higher, the number of fans to be required to participate in the race is increased.

In this way, a plurality of clear goals are set for each character. By achieving the clear goals, the player can continue the nurture main game until the final turn. On the other hand, in the case where the clear goals cannot be achieved, the nurture main game is ended in the corresponding turn.

As described above, in the nurture-target character selection screen 150, which is shown in FIG. 5A, the player can select a nurture-target character while confirming various kinds of information on the individual characters. Then, when the next operation section 154 is tapped in the nurture-target character selection screen 150, the selected character is set as the nurture-target character, and an inheritance character selection screen 170 is displayed on the display 26.

### <Registration of Inheritance Characters>

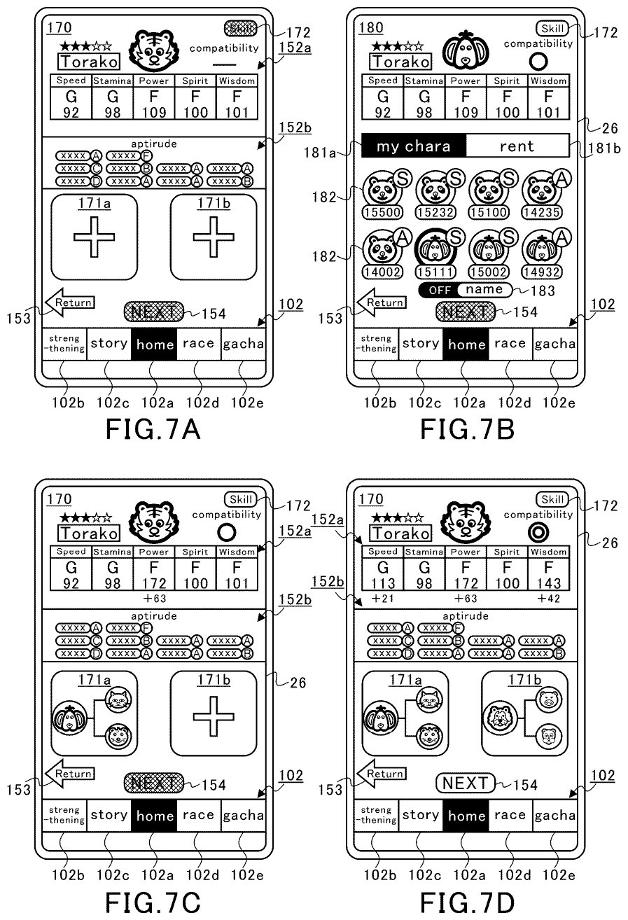

FIG. 7A is a first view for explaining the inheritance character selection screen 170. FIG. 7B is a first view for explaining a nurtured-character list screen 180. FIG. 7C is a second view for explaining the inheritance character selection screen 170. FIG. 7D is a third view for explaining the inheritance character selection screen 170. The inheritance character selection screen 170 is a screen in which the player registers inheritance characters.

The inheritance characters are characters from which the nurture-target character inherits the ability values, the skills, etc., of the inheritance characters. The player can select two inheritance characters, from among the nurtured characters possessed by the player himself/herself and a representative character of another player, e.g., a representative character of a friend, such as a follower, extracted according to a predetermined extraction condition, organize the two inheritance characters in a deck, and register the inheritance characters. Note that only one representative character of another player can be organized in a deck as an inheritance character in one nurture game.

In the inheritance character selection screen 170, the ability-parameter display section 152a, the aptitude-parameter display section 152b, a first inheritance-character selection area 171a, and a second inheritance-character selection area 171b are provided. When the screen is transitioned from the nurture-target character selection screen 150 to the inheritance character selection screen 170, the first inheritance-character selection area 171a and the second inheritance-character selection area 171b are displayed in blank, as shown in FIG. 7A.

When the first inheritance-character selection area 171a or the second inheritance-character selection area 171b is tapped, the nurtured-character list screen 180, which is shown in FIG. 7B, is displayed. In the nurtured-character list screen 180, a my-character tab 181a and a rental tab 181b are provided. Furthermore, a nurtured-character-list display area is provided below the my-character tab 181a and the rental tab 181b. In the nurtured-character-list display area, nurtured-character icons 182 are displayed.

In a state in which the my-character tab 181a is selected, the nurtured-character icons 182 corresponding to the nurtured characters possessed by the player himself/herself are displayed, as shown in FIG. 7B. Furthermore, although not shown in the figures, in a state in which the rental tab 181b is selected, the nurtured-character icons 182 corresponding to representative characters of friends, i.e., nurtured characters that have been nurtured by the friends, are displayed.

Furthermore, when any of the nurtured-character icons 182 is tapped, the nurtured character corresponding to the tapped nurtured-character icon 182 is temporarily selected. Furthermore, when this nurtured-character icon 182 is tapped, the inheritance character selection screen 170 is displayed as shown in FIG. 7C. At this time, for example, in the case where the first inheritance-character selection area 171a is tapped, the nurtured-character list screen 180 is thus displayed, and any of the nurtured-character icons 182 is tapped in the nurtured-character list screen 180, an image indicating the nurtured character that is temporarily selected is displayed in the first inheritance-character selection area 171a.

In this state, for example, when the second inheritance-character selection area 171b is tapped, the nurtured-character list screen 180 is thus displayed, and any of the nurtured-character icons 182 is tapped in the nurtured-character list screen 180, an image indicating the nurtured character that is temporarily selected is displayed in the second inheritance-character selection area 171b, as shown in FIG. 7D.

Furthermore, information related to inheritance characters that were used when each nurtured character was nurtured is stored while being linked to the nurtured character. In the first inheritance-character selection area 171a, the information related to the inheritance characters that were used when the nurtured character was nurtured is displayed.

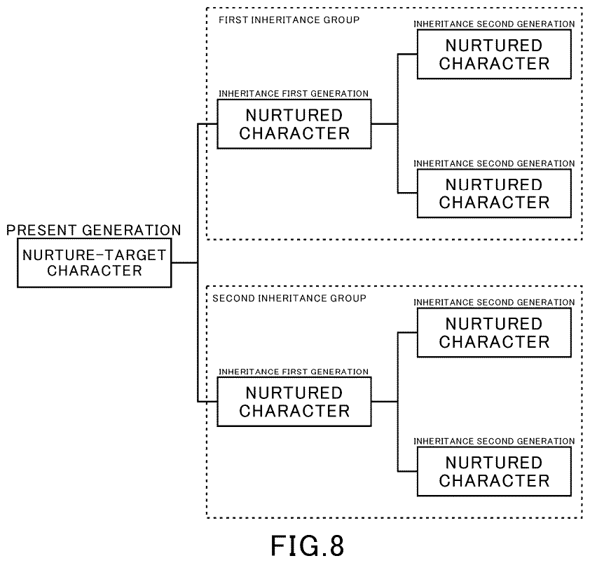

FIG. 8 is a view for explaining lineage of inheritance. In the nurture game, various benefits, such as an increase in the values of the ability parameters and the aptitude parameters of the nurture-target character, are provided on the basis of factor information of inheritance characters. Here, two inheritance characters are set for one nurture-target character, and these inheritance characters are nurtured characters that were generated earlier. Therefore, when the nurtured characters to be set as inheritance characters were generated, two inheritance characters were also set for each of these nurtured characters.

As shown in FIG. 8, a nurture-target character in a nurture main game to be started from now is referred to as a character in the present generation. Furthermore, two nurtured characters set as inheritance characters for this nurture-target character are referred to as characters in an inheritance first generation. Furthermore, when nurture of each of the nurtured characters in the inheritance first generation was started, two nurtured characters were set as inheritance characters. The two nurtured characters set as the inheritance characters when each of the nurtured characters in the inheritance first generation was generated are referred to as characters in an inheritance second generation.

In this case, the nurtured characters in the inheritance first generation and in the inheritance second generation bring benefits to the nurture-target character in the present generation, as shown in FIG. 8. As described above, since two inheritance characters (in the inheritance first generation) are set for one nurture-target character, six nurtured characters in total bring benefits to one nurture-target character.

For example, one of the two nurtured characters in the inheritance first generation and the two nurtured characters in the inheritance second generation that are inheritance characters for this nurtured character are formed in a first inheritance group. Similarly, the other one of the two nurtured characters in the inheritance first generation and the two nurtured characters in the inheritance second generation that are inheritance characters for this nurtured character are formed in a second inheritance group.

As shown in FIG. 7D, icons individually corresponding to one nurtured character in the inheritance first generation and two nurtured characters in the inheritance second generation, these nurtured characters constituting the first inheritance group, are displayed in the first inheritance-character selection area 171a. Similarly, icons individually corresponding to one nurtured character in the inheritance first generation and two nurtured characters in the inheritance second generation, these nurtured characters constituting the second inheritance group, are displayed in the second inheritance-character selection area 171b.

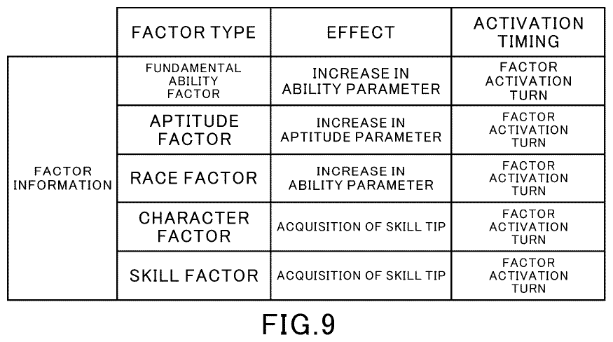

FIG. 9 is a view for explaining factor information. Although a detailed description will be given later, the nurture-target character is registered as a nurtured character when the nurture game is completed, and, at this time, factor information is stored while being linked to the nurtured character. Specifically, when nurture of the nurtured character is completed, factors to be obtained by the nurtured character are determined by a lottery. Then, factor information indicating factors won by a lottery is linked to the nurtured character. In other words, when the nurture game is completed, the nurtured character can obtain factors won by a lottery.

However, the factors obtained by the nurtured character do not affect the abilities of this nurtured character. For example, the nurtured character can be made to participate in a race game such as a team competition game. At this time, in such a race, simulation, that is, arithmetic processing, for determining the order of arrival and the race development is performed on the basis of the ability parameters, the aptitude parameters, the obtained skills, etc., of all nurtured characters that participate in the race. Since the factors held by the nurtured characters are not used in the arithmetic processing, even if many factors are held, the race is not advantageously proceeded with.

The factors held by a nurtured character affect only the nurture-target character in the case where this nurtured character is set as an inheritance character. Factors that can be obtained by a nurtured character are classified into a plurality of types. FIG. 9 shows, as factor types, a fundamental ability factor, an aptitude factor, a race factor, a character factor, and a skill factor. Either of a plurality of stages is set for each of the factors. Here, three stages of factor levels, i.e., level 1, level 2, and level 3, are provided as stages of a factor.

Note that the factor level is determined by a lottery. At this time, it is also possible that, after factors to be obtained by a nurtured character are determined, the factor levels for the individual obtained factors are determined by a lottery. Alternatively, it is also possible that a winning ratio is set for each combination pattern of a factor and a factor level, and any combination pattern is determined on the basis of the set winning ratio. In this case, a factor to be obtained and a factor level thereof are determined at the same time.

Among the factor levels, level 3 is the most effective, and level 1 is the least effective. In the lottery for determining a factor level, the lowest winning rate is set for level 3, and the highest winning rate is set for level 1. However, the winning rate for a factor to be obtained and the winning rate for a factor level may change depending on the result of the nurture game. In this case, for example, a higher factor level may be determined as a nurtured character has higher ability parameters and higher evaluation points.

The fundamental ability factor increases the corresponding ability parameter of the nurture-target character. The fundamental ability factor includes five factors, i.e., a speed factor, a stamina factor, a power factor, a spirit factor, and a wisdom factor. A nurtured character always obtains one fundamental ability factor among the five fundamental ability factors. The five fundamental ability factors respectively correspond to the five ability parameters of speed, stamina, power, spirit, and wisdom. For example, in the case where a nurtured character in the inheritance first generation or in the inheritance second generation has the speed factor, the ability parameter of speed of the nurture-target character will be increased.

At this time, an increase value for the ability parameter of speed differs depending on the factor level of the speed factor. For example, in the case where the factor level of the speed factor is level 1, the ability parameter of speed of the nurture-target character is increased by “7”, in the case where the factor level thereof is level 2, the ability parameter thereof is increased by “13”, and, in the case where the factor level thereof is level 3, the ability parameter thereof is increased by “21”. Therefore, in the case where the total of six nurtured characters, including two nurtured characters in the inheritance first generation and four nurtured characters in the inheritance second generation, all have the speed factor of level 3, the ability parameter of speed of the nurture-target character is increased by 126 at most (increase value 21×six nurtured characters).

However, an activation timing and an activation condition are set for each factor. Therefore, even when an inheritance character has a factor, if the activation condition is not established at the activation timing, the benefit is not brought to the nurture-target character.

As described above, the nurture main game is composed of a plurality of turns, and predetermined turns of the turns are set as factor activation turns. For example, it is assumed that three turns, e.g., the 1st turn, the 30th turn, and the 54th turn, in the nurture main game are set as the factor activation turns. In these factor activation turns, it is determined, for each factor, whether the factor is to be activated or not. In the case where it is determined that the factor is to be activated, the activation condition for this factor is established, and the benefit corresponding to the factor is brought.

Note that whether the fundamental ability factor is activated or not is determined by a lottery. At this time, the winning rate of the lottery as to whether the fundamental ability factor is activated or not, that is, the rate of activating the fundamental ability factor (hereinafter, referred to as activation rate), may be different in the three factor activation turns. Here, in the 1st turn, the activation rate of the fundamental ability factor is set to 100% regardless of the factor level. Furthermore, in the 30th turn and the 54th turn, the activation rate of the fundamental ability factor is different depending on the factor level. In one example, in the 30th turn and the 54th turn, the activation rate of the fundamental ability factor of level 3 is set to 100%, the activation rate of the fundamental ability factor of level 2 is set to 90%, and the activation rate of the fundamental ability factor of level 1 is set to 80%.

In the inheritance character selection screen 170, an increase value(s) by which the ability parameter(s) is to be increased in the 1st turn is displayed for the ability parameter(s). For example, in FIG. 7C, one inheritance character that constitutes the first inheritance group is temporarily selected. In this case, the kind of the ability parameter to be increased in the 1st turn due to the temporarily selected one inheritance character and an increase value therefor are displayed. Here, “+63” is displayed below the ability parameter of power, which indicates that the ability parameter of power will be increased in the 1st turn by 63 points. Furthermore, the value obtained by adding the increase value, by which the ability parameter is to be increased in the 1st turn, is displayed in the ability-parameter display section 152a.

Furthermore, in FIG. 7D, two inheritance characters that constitute the first inheritance group and the second inheritance group are temporarily selected. In this case, the kinds of the ability parameters to be increased in the 1st turn due to the temporarily selected two inheritance characters and increase values thereof are displayed. Here, “+21”, “+63”, and “+42” are respectively displayed below the ability parameters of speed, power, and wisdom, which indicates that the ability parameters of speed, power, and wisdom will be increased in the 1st turn by 21 points, 63 points, and 42 points, respectively.

Note that, in the inheritance character selection screen 170, the increase value for the ability parameter to be increased due to the inheritance character that constitutes the first inheritance group and the increase values for the ability parameters to be increased due to the inheritance character that constitutes the second inheritance group are displayed in an identifiable manner. For example, in FIG. 7D, the color of “+63” displayed below the ability parameter of power is different from that of “+21” and “+42” displayed below the ability parameters of speed and wisdom.

The aptitude factor shown in FIG. 9 increases the corresponding aptitude parameter of the nurture-target character. The aptitude factor includes six factors, i.e., a turf factor, a dirt factor, a short-distance factor, a mile factor, a middle-distance factor, and a long-distance factor. A nurtured character always obtains one aptitude factor among the six aptitude factors. The six aptitude factors respectively correspond to a turf aptitude, a dirt aptitude, a short-distance aptitude, a mile aptitude, a middle-distance aptitude, and a long-distance aptitude. For example, in the case where a nurtured character that has the turf factor is included in the nurtured characters in the inheritance first generation or in the inheritance second generation, the aptitude parameter of the turf aptitude of the nurture-target character will be increased.

Note that an activation timing and an activation condition are also set for each aptitude factor, and, in the same factor activation turns as for the fundamental ability factor, it is determined, for each aptitude factor, whether the aptitude factor is to be activated or not. In the case where it is determined that the aptitude factor is to be activated, the corresponding aptitude parameter is increased by one stage. In one example, in the 1st turn, the activation rate of the aptitude factor is set to 100% regardless of the factor level.

For example, it is assumed that the aptitude factors of the three nurtured characters that belong to the first inheritance group are respectively the turf factor, the short-distance factor, and the mile factor, and the aptitude factors of the three nurtured characters that belong to the second inheritance group are respectively the turf factor, the short-distance factor, and the middle-distance factor. In this case, the turf aptitude and the short-distance aptitude of the nurture-target character are individually increased by two stages, and the mile aptitude and the middle-distance aptitude thereof are individually increased by one stage.

Furthermore, for example, it is assumed that the aptitude factors of the three nurtured characters that belong to the first inheritance group are all the turf factor, and the aptitude factors of the three nurtured characters that belong to the second inheritance group are all the short-distance factor. In this case, the turf aptitude and the short-distance aptitude of the nurture-target character are individually increased by three stages. Furthermore, in still another example, it is assumed that the aptitude factors of the three nurtured characters that belong to the first inheritance group are all the turf factor, and the aptitude factors of the three nurtured characters that belong to the second inheritance group are respectively the turf factor, the short-distance factor, and the mile factor. In this case, the turf aptitude of the nurture-target character is increased by four stages, and the short-distance aptitude and the mile aptitude thereof are individually increased by one stage.

However, in the 1st turn, a limitation is set on the increase values for the aptitude parameters. Specifically, in the 1st turn, the upper limit for all the aptitude parameters is set to A. Therefore, in the case where the initial value of the turf aptitude of the nurture-target character is A, the turf aptitude will not be increased in the 1st turn even if any of the inheritance characters has the turf factor.

In contrast to this, in the 30th turn and the 54th turn, a lottery is performed, for each aptitude factor, to determine whether the aptitude factor is to be activated or not on the basis of the factor level. In one example, in the 30th turn and the 54th turn, the activation rate of the aptitude factor of level 3 is set to 5%, the activation rate of the aptitude factor of level 2 is set to 3%, and the activation rate of the aptitude factor of level 1 is set to 1%. In the 30th turn or the 54th turn, when it is determined by the lottery that the aptitude factor is to be activated, the aptitude parameter corresponding to the aptitude factor is increased. Note that, in the 30th turn and the 54th turn, the upper limit for each aptitude is raised from A to S. Therefore, in the 30th turn and the 54th turn, the value of the corresponding aptitude parameter can be increased up to S through activation of the aptitude factor.

Note that the value(s) of the aptitude parameter(s) that has been increased in the 1st turn is displayed in the aptitude-parameter display section 152b of the inheritance character selection screen 170.

The race factor increases the corresponding ability parameter of the nurture-target character. The race factor is provided for each race of a high difficulty level, for example, GI, (hereinafter, referred to as factor target race) among races in each of which participation is allowed in the nurture main game. When the nurture game is completed, a lottery is performed for each factor target race in which the nurture-target character came in 1st place, to determine whether the race factor is to be obtained or not. By winning the lottery, the nurtured character can obtain the race factor.

Note that a factor level is provided in the race factor, and, for each race factor that has been determined to be obtained, the factor level thereof is determined by a lottery. Furthermore, here, there is no upper limit on the number of race factors that can be obtained by one nurtured character, and a nurtured character can obtain a plurality of race factors.

For each race factor, an ability parameter to be increased through activation of the race factor and an increase value therefor are set in advance. For example, race factors include a factor for increasing the ability parameter of speed and a factor for increasing the ability parameter of power. At this time, an increase value for the ability parameter is increased as the factor level becomes higher.

Furthermore, an activation timing and an activation condition are also set for each race factor, and, in the factor activation turns, it is determined, for each race factor, whether the race factor is to be activated or not. In the case where it is determined that the race factor is to be activated, the ability parameter corresponding to the race factor is increased. Note that the factor activation turns for the race factors are limited to the 30th turn and the 54th turn. Furthermore, the activation rate of each of the race factors in the factor activation turns is different depending on the factor level, and the activation rate is increased as the factor level becomes higher.

The character factor is a factor unique to a character, and, for example, only in the case where a character strengthened to a predetermined level is nurtured as the nurture-target character, the character factor set for this character is always given to the nurtured character when the nurture game is completed. Note that, since only one character factor is set for one character, one nurtured character can obtain at most one character factor.

Furthermore, in the case where a nurtured character is generated on the basis of a character that has not been strengthened to the predetermined level, the character factor cannot be obtained.

Furthermore, the character factor can be activated in a factor activation turn set in advance and is activated by winning a lottery executed in the factor activation turn. When the character factor is activated, a tip event set for the character factor occurs, and a tip for a skill can be obtained, as described above.

The skill factor is given on the basis of an obtained skill that has been obtained by a nurtured character. Specifically, when the nurture game is completed, a lottery is performed, for each of the obtained skills that have been obtained by the nurtured character, to determine whether the corresponding skill factor is to be obtained or not. By winning the lottery, the skill factor is given to the nurtured character. That is, the nurtured character can obtain part or all of the skill factors corresponding to the obtained skills. Note that, when it is determined that a skill factor is obtained, the factor level of the skill factor is determined by a lottery.

Furthermore, the skill factor can be activated in a factor activation turn set in advance and is activated by winning a lottery executed in the factor activation turn. At this time, the winning rate is increased as the factor level is higher. When the skill factor is activated, a tip event set for the skill factor occurs, and a tip for a skill can be obtained. Accordingly, the nurture-target character can obtain the same skills as the obtained skills that have been obtained by the inheritance characters.

In this way, whether a skill factor is obtained or not is determined within the range of the obtained skills that have been obtained by the nurtured character. Therefore, the possibility of obtaining skill factors is increased as the nurtured character has more obtained skills. However, since whether a skill factor is obtained or not is determined by a lottery, even if the nurtured character has many obtained skills, skill factors may not be obtained, in some cases.

Note that, although, here, a nurtured character obtains a skill factor separately from an obtained skill, it is also possible that skill factors are not provided, and skills that can be obtained by the nurture-target character are determined on the basis of the obtained skills held by the nurtured characters serving as the inheritance characters.

As described above, the ability parameters of the nurture-target character significantly change depending on the inheritance characters organized in the deck. Furthermore, even if the abilities of a nurtured character itself are high, whether each factor is to be obtained or not is determined by a lottery; thus, it is not always the case that a nurtured character having high abilities is suitable as an inheritance character. On the other hand, even in the case where the abilities of a nurtured character itself are not high, the nurtured character effectively functions as an inheritance character by obtaining many factors of high factor levels, in some cases. In this way, inheritance characters can be organized in a deck, thereby bringing an interest not only in nurturing a simply powerful nurtured character but also in nurturing the nurtured character effective as an inheritance character.

Furthermore, in this embodiment, the compatibility is judged among the nurture-target character, a nurtured character in the inheritance first generation, and a nurtured character in the inheritance second generation. Then, in the case of a combination of characters having a good compatibility, the activation conditions for factors become advantageous.

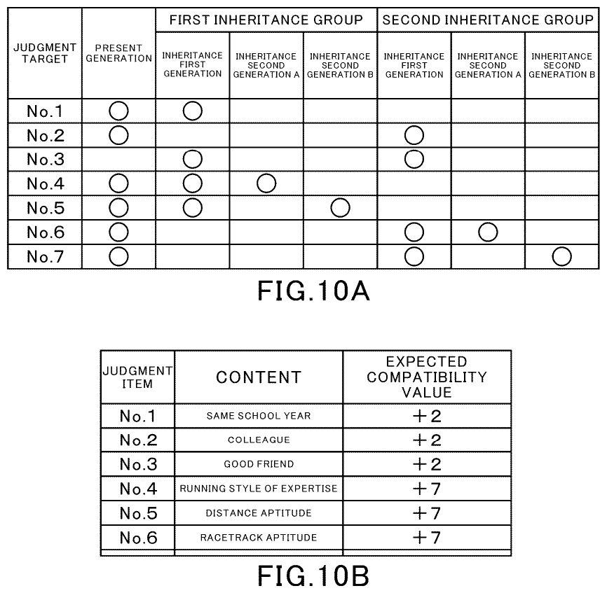

FIG. 10A is a view for explaining compatibility judgment targets, and FIG. 10B is a view for explaining compatibility judgment items. As shown in FIG. 10A, in this embodiment, seven judgment targets from No. 1 to No. 7 are provided. A first judgment target (No. 1) includes the nurture-target character in the present generation and a nurtured character in the inheritance first generation in the first inheritance group. A second judgment target (No. 2) includes the nurture-target character in the present generation and a nurtured character in the inheritance first generation in the second inheritance group.

A third judgment target (No. 3) includes the nurtured character in the inheritance first generation in the first inheritance group and the nurtured character in the inheritance first generation in the second inheritance group. A fourth judgment target (No. 4) includes the nurture-target character in the present generation, the nurtured character in the inheritance first generation in the first inheritance group, and one (nurtured character A) of the nurtured characters in the inheritance second generation in the first inheritance group. A fifth judgment target (No. 5) includes the nurture-target character in the present generation, the nurtured character in the inheritance first generation in the first inheritance group, and the other one (nurtured character B) of the nurtured characters in the inheritance second generation in the first inheritance group.

A sixth judgment target (No. 6) includes the nurture-target character in the present generation, the nurtured character in the inheritance first generation in the second inheritance group, and one (nurtured character A) of the nurtured characters in the inheritance second generation in the second inheritance group. A seventh judgment target (No. 7) includes the nurture-target character in the present generation, the nurtured character in the inheritance first generation in the second inheritance group, and the other one (nurtured character B) of the nurtured characters in the inheritance second generation in the second inheritance group.

For each of the judgment targets, whether a condition is established or not is judged with respect to each of a plurality of judgment items. FIG. 10B shows examples of the judgment items. In this embodiment, a worldview of the game is set in which characters that can each be selected as the nurture-target character are students, and the individual characters do trainings at school.

Then, as shown in FIG. 10B, school year, colleague, and good friend are set in advance for the characters. The judgment items include items of content indicating, for example, whether two or three judgment-target characters are in the same school year, are colleagues, or are good friends. Furthermore, the judgment items include items of content indicating whether the judgment-target characters have the same best running style, distance aptitude, or racetrack aptitude.

Then, expected compatibility values are linked to the judgment items, and the expected compatibility values of the judgment items that are established between the judgment-target characters are accumulated. Here, although the expected compatibility values are different depending on the judgment items, the expected compatibility values may be common to all the judgment items.

For example, in the case where the compatibility is to be judged, first it is judged whether the judgment items are each established or not between the nurture-target character in the present generation and the nurtured character in the inheritance first generation in the first inheritance group, which are included in the first judgment target. At this time, the expected compatibility value linked to an established judgment item is accumulated and counted. In this way, the expected compatibility value is counted sequentially from the first judgment target to the seventh judgment target, and the activation rates of factors are corrected on the basis of the finally calculated expected compatibility value. That is, the activation rates of all factors are increased as the expected compatibility value becomes higher, and the activation rates of all factors are decreased as the expected compatibility value becomes lower.

Note that the activation rates may be calculated by using the calculated expected compatibility value as a correction value. Furthermore, for example, a correction value for correcting the activation rates of factors may be set for each compatibility level, and the compatibility level may be determined by the calculated expected compatibility value.

In this way, since the activation rates of factors are different depending on the compatibility between the nurture-target character and an inheritance character or the compatibility between inheritance characters, a combination of two inheritance characters have a great influence on the nurture of the nurture-target character. That is, the compatibility between characters is an important judgment material in selecting inheritance characters.

As shown in FIGS. 7B, 7C, and 7D, with inheritance characters being selected, a compatibility mark indicating the compatibility is displayed at an upper right section of the inheritance character selection screen 170 and the nurtured-character list screen 180. Here, the compatibility level of the selected characters is indicated by any of three compatibility marks, i.e., a double circle, a single circle, and a triangle. Note that, as shown in FIG. 7A, with no inheritance characters being selected, none of the compatibility marks is displayed.

Furthermore, as shown in FIG. 7B, a display switch button 183 is provided in the nurtured-character list screen 180. When the display switch button 183 is operated, a display condition setting screen (not shown) is displayed. In the display condition setting screen, the player can sort or filter the nurtured-character icons 182 to be displayed in the nurtured-character list screen 180, that is, the nurtured characters that can be selected as inheritance characters.

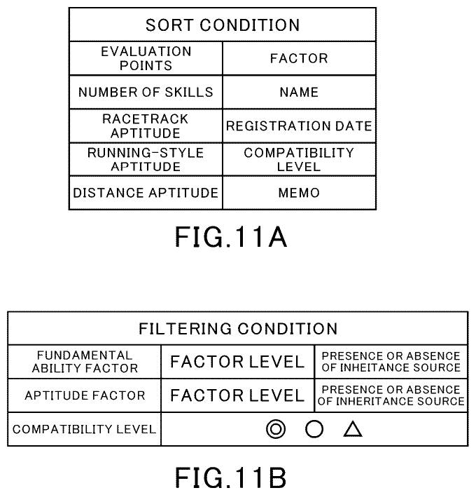

FIG. 11A is a view for explaining a sort condition. FIG. 11B is a view for explaining a filtering condition. In the display condition setting screen, the player can select and set a sort condition shown in FIG. 11A. Here, it is possible to select and set, as a sort condition, any of the evaluation points, a factor, the number of skills, the name, the racetrack aptitude, the registration date, the running-style aptitude, the compatibility level, the distance aptitude, and a memo. When a sort condition is set, the nurtured-character list screen 180 is displayed. At this time, the display order of the nurtured-character icons 182 has been changed according to the sort condition, in the nurtured-character list screen 180.

Furthermore, in the display condition setting screen, the player can select and set a filtering condition shown in FIG. 11B. Here, the fundamental ability factor, the aptitude factor, and the compatibility level are provided as filtering conditions. Note that, when the fundamental ability factor or the aptitude factor is set as a filtering condition, only the nurtured characters that have the factor selected by the player are displayed in the nurtured-character list screen 180.

At this time, the player can set the factor level. For example, when filtering is performed by setting the factor level to level 3, only the nurtured characters that have the factor(s) of level 3, among the factor(s) selected by the player, are displayed in the nurtured-character list screen 180. Note that the player can select whether a factor is held by the nurtured characters themselves or is held by inheritance characters of the nurtured characters, to perform filtering of the nurtured characters.

Furthermore, the player can perform filtering based on the compatibility level. Here, it is possible to filter nurtured characters having a compatibility of double circle, nurtured characters having a compatibility of single circle, or nurtured characters having a compatibility of triangle. In this way, it is possible to perform sorting and filtering by various conditions, whereby the convenience of the player is improved.

Furthermore, when any of the nurtured-character icons 182 is pressed and held in the nurtured-character list screen 180, which is shown in FIG. 7B, detailed information on the nurtured character corresponding to the nurtured-character icon 182 is displayed.

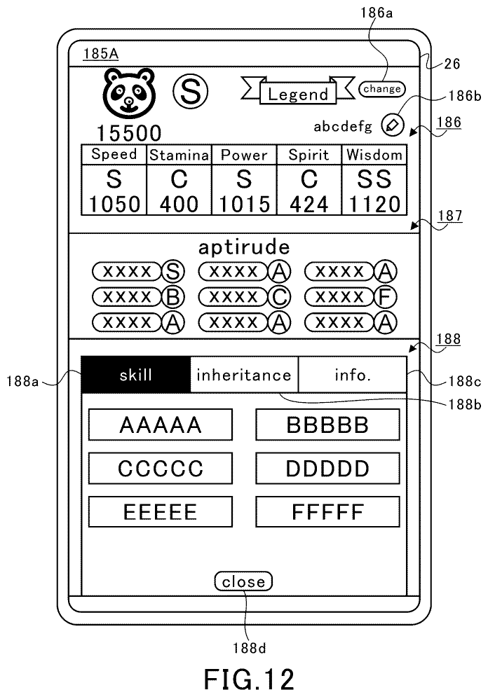

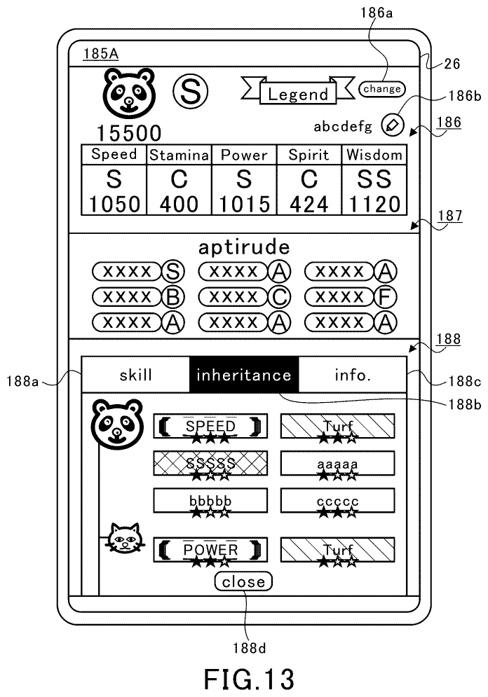

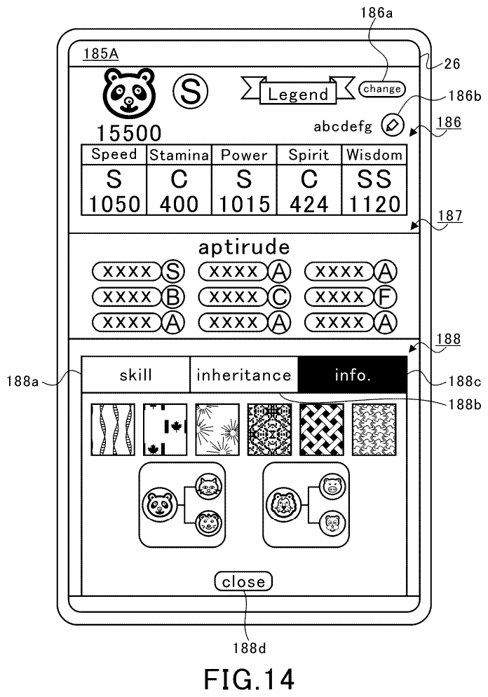

FIG. 12 is a first view for explaining a character detail dialog 185A. FIG. 13 is a second view for explaining the character detail dialog 185A. FIG. 14 is a third view for explaining the character detail dialog 185A. In the character detail dialog 185A, detailed information on the nurtured character is displayed. An ability-parameter display field 186 indicating the ability parameters of the nurtured character is displayed at an upper section of the character detail dialog 185A.

At the upper left of the ability-parameter display field 186, an icon indicating the character that is the basis of the nurtured character and the evaluation points and the nurture rank of the nurtured character are displayed. Furthermore, a nickname change button 186a and a memo input button 186b are provided at the upper right of the ability-parameter display field 186. When the nickname change button 186a is tapped, a nickname list screen (not shown) is displayed. In the nickname list screen, nicknames obtained by the nurtured character are displayed in a list. Note that, in the nurture main game, a number of nicknames are provided, and an acquisition condition is set for each of all the nicknames.

In the nurture main game, a nickname for which the acquisition condition is satisfied is given to the nurtured character. The player can select one from among the nicknames obtained by the nurtured character and set the nickname for the nurtured character. The player can change the nickname to be set for the nurtured character, in the nickname list screen. The currently set nickname (here, Legend) is displayed at the left side of the nickname change button 186a.

Note that examples of the nickname acquisition condition are that the nurture-target character obtains a predetermined number of fans, that the ability parameters or the aptitude parameters are equal to or higher than a predetermined value, that a predetermined skill is obtained, that the number of race wins is equal to or higher than a predetermined number, and that a predetermined order of arrival (for example, the 1st place) is obtained in a specific race.

Furthermore, when the memo input button 186b is tapped, a letter input screen (not shown) is displayed. In the letter input screen, 9 letters or less can be input in, for example, Hiragana, Katakana, numbers, Roman alphabets, etc. Letters that are input in the letter input screen are stored, as a memo, while being linked to the nurtured character. In the case where a memo is stored for the nurtured character, the memo (here, abcdefg) is displayed at the left side of the memo input button 186b.

Note that the above-mentioned memo is included in the sort conditions for the nurtured-character icons 182 in the nurtured-character list screen 180. Therefore, when the player registers a memo while making it linked to each nurtured character, it becomes easier to search for a nurtured character to be used as an inheritance character.

Furthermore, an aptitude information display field 187 is displayed below the ability-parameter display field 186. In the aptitude information display field 187, displayed are: aptitude parameters related to the racetrack aptitudes for turf and dirt; aptitude parameters related to the distance aptitudes for short distance, mile, middle distance, and long distance; and aptitude parameters related to the running-style aptitudes for runaway winner, front runner, come-from-behind runner, and stretch runner.

A various-kinds-of-information display field 188 is displayed below the aptitude information display field 187. In the various-kinds-of-information display field 188, a skill display tab 188a, an inheritance information display tab 188b, a nurture information display tab 188c, and a close operation section 188d are provided. When the skill display tab 188a is tapped, obtained skills of the nurtured character are displayed in the various-kinds-of-information display field 188, as shown in FIG. 12. Furthermore, when the inheritance information display tab 188b is tapped, inheritance information of the nurtured character is displayed, as shown in FIG. 13.

Note that, in the various-kinds-of-information display field 188, the inheritance information is displayed on the basis of the nurtured character that can be set as an inheritance character and the inheritance characters that have been used for the nurture of the nurtured character. The inheritance information includes: information on the inheritance characters that have been used for the nurture of this nurtured character; factor information of the nurtured character; and factor information of the inheritance characters. Here, the inheritance information is displayed in a list for each nurtured character.

Specifically, factor information linked to the nurtured character and factor information linked to the inheritance characters for the nurtured character are displayed for each character. Therefore, the player can confirm the factor information of the three characters by scrolling the various-kinds-of-information display field 188 in the vertical direction.

In the various-kinds-of-information display field 188, the fundamental ability factor, the aptitude factor, and the character factor are displayed in different colors. For example, the fundamental ability factor is displayed in blue, the aptitude factor is displayed in red, and the character factor is displayed in green. Note that, in the various-kinds-of-information display field 188, the race factor(s) and the skill factor(s) are displayed in white. Furthermore, stars indicating the factor level are displayed for each piece of factor information so as to be overlaid thereon.

Furthermore, when the nurture information display tab 188c is tapped, nurture information on the nurtured character is displayed, as shown in FIG. 14. Note that the nurture information includes: the types of support cards that have been used to nurture the nurtured character; the characters in the inheritance first generation and the inheritance second generation; the results of races in the nurture game; and the evaluation points.

In this way, the player can confirm various kinds of information related to the nurtured character, in the character detail dialog 185A. Therefore, it is easy for the player to grasp information linked to inheritance characters to be organized into a deck, whereby it is possible to improve the convenience of the player.

Note that, when the close operation section 188d is tapped in the character detail dialog 185A, the character detail dialog 185A is closed, and the nurtured-character list screen 180 is displayed on the display 26. Furthermore, as shown in FIGS. 7A, 7B, 7C, and 7D, a skill display button 172 is provided at an upper right section of the inheritance character selection screen 170 and the nurtured-character list screen 180. When the skill display button 172 is tapped, skills that can be obtained due to the nurtured character(s) temporarily selected as an inheritance character(s) are displayed in a list.

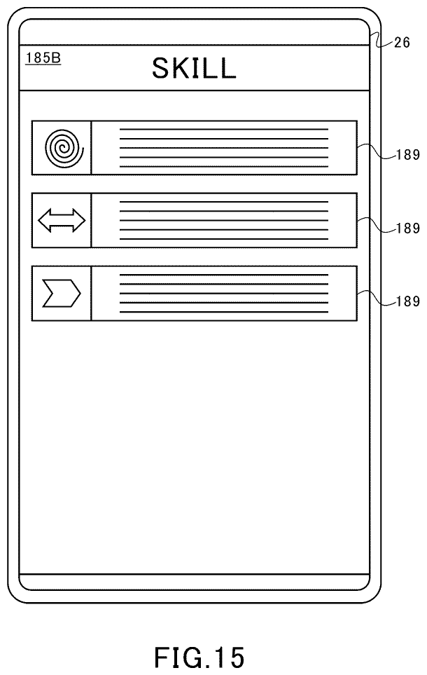

FIG. 15 is a view for explaining a skill display dialog 185B. In the skill display dialog 185B, skill explanation display fields 189 are displayed, each of which shows an icon corresponding to a skill and the content of the skill. In the skill explanation display fields 189, all skills that can be obtained by the nurture-target character in the case where the currently selected nurtured character(s) is used as an inheritance character(s) are displayed in a list.

That is, pieces of information related to the skills linked to the character factor(s) or the skill factor(s) of the nurtured character(s) are displayed in a list in the skill display dialog 185B. As shown in FIG. 7C, in the case where the skill display button 172 is tapped with one nurtured character being selected as an inheritance character, skills linked to the character factor and the race factor(s) of this one nurtured character (inheritance character) are displayed in the skill display dialog 185B.

On the other hand, as shown in FIG. 7D, in the case where the skill display button 172 is tapped with two nurtured characters being selected as inheritance characters, skills linked to the character factors and the race factors of the two nurtured characters (inheritance characters) are displayed in the skill display dialog 185B.

As described above, in this embodiment, in the character detail dialog 185A, inheritance information (factor information) is displayed in a list for each nurtured character that can be set as an inheritance character. Furthermore, in the skill display dialog 185B, information (skills) linked to the inheritance information (factor information) is displayed in a list. At this time, the character detail dialog 185A and the skill display dialog 185B are displayed on the basis of the nurtured character that can be set as an inheritance character and the inheritance characters that have been used for nurture of the nurtured character. The convenience of the player is improved by displaying the character detail dialog 185A and the skill display dialog 185B.

Then, when two nurtured characters are temporarily selected, a next operation section 154 provided in the inheritance character selection screen 170 is enabled. When the enabled next operation section 154 is tapped, the nurtured characters that are temporarily selected are temporarily registered in a deck as inheritance characters, and a support-card organization screen 190, to be described later, is displayed.

Note that the player always has to select two nurtured characters as inheritance characters in the inheritance character selection screen 170. In the case where two inheritance characters have not been temporarily selected, the next operation section 154 is grayed out, as shown in FIGS. 7A and 7C, thus being disabled to accept a player's operation. Furthermore, a return operation section 153 is provided in the inheritance character selection screen 170, and, when the return operation section 153 is tapped, the nurture-target-character selection screen 150 is displayed.

### <Registration of Support Cards>

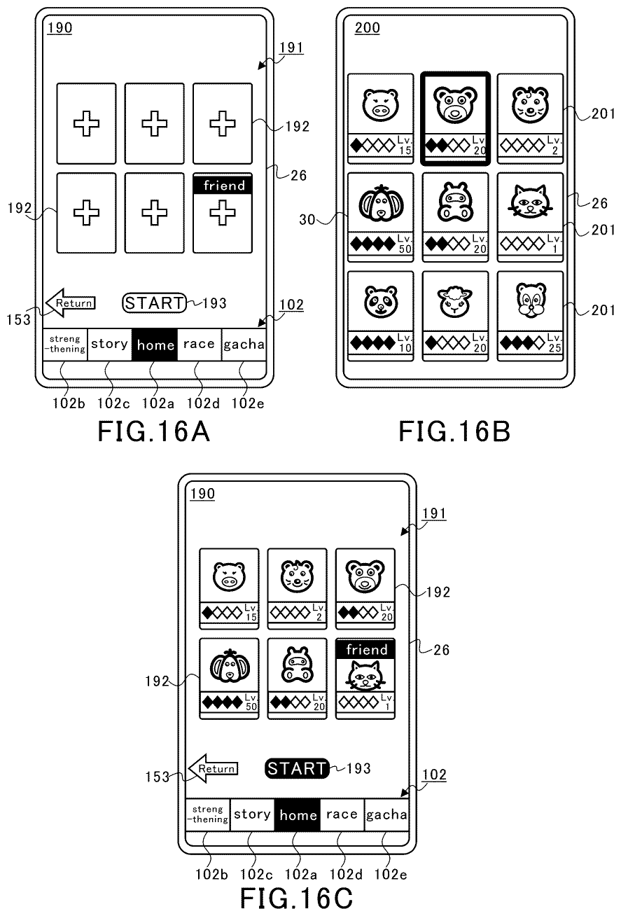

FIG. 16A is a first view for explaining the support-card organization screen 190. When two inheritance characters are registered in the inheritance character selection screen 170, the support-card organization screen 190, which is shown in FIG. 16A, is displayed. A support-card display area 191 is provided at a central section of the support-card organization screen 190. A plurality of support-card display frames 192 are included in the support-card display area 191.

Furthermore, a return operation section 153, in which “Return” is written, and a start operation section 193, in which “START” is written, are displayed at a lower section of the support-card organization screen 190.

The plurality of (here, six) support-card display frames 192 are displayed in the support-card display area 191. The same number of support-card display frames 192 as the number of support cards that can be set by the player is displayed. Note that, when the support-card organization screen 190 is displayed at first, the support-card display frames 192 are displayed in blank.

In this embodiment, the player can set six kinds of support cards in the deck. Note that part (for example, five kinds) of the six kinds of support cards, which can be set by the player, can be selected from among support cards that are possessed by the player. Furthermore, the other part (for example, one kind) of the six kinds of support cards, which can be set by the player, can be selected from among support cards that are set as rental cards by another player such as a friend.

FIG. 16B is a view for explaining a support-card selection screen 200. When any of the support-card display frames 192 (except the support-card display frame 192 that is displayed at the lower right) is tapped in the support-card organization screen 190 shown in FIG. 16A, the support-card selection screen 200, which is shown in FIG. 16B, is displayed on the display 26. In the support-card selection screen 200, card icons 201 corresponding to support cards possessed by the player are displayed in a list. The player can select support cards by tapping the corresponding card icons 201 displayed in the support-card selection screen 200.

Note that, although not shown in the figures, when the support-card display frame 192 that is displayed at the lower right is tapped in the support-card organization screen 190, a support card(s) that is set as a rental card(s) by a friend or a player extracted on the basis of a predetermined condition such as a lottery, for example, is displayed in the support-card selection screen 200. The player can select one support card of the friend by tapping the support card displayed at this time in the support-card selection screen 200. In this way, the player can use a support card possessed by another player, in the nurture game.

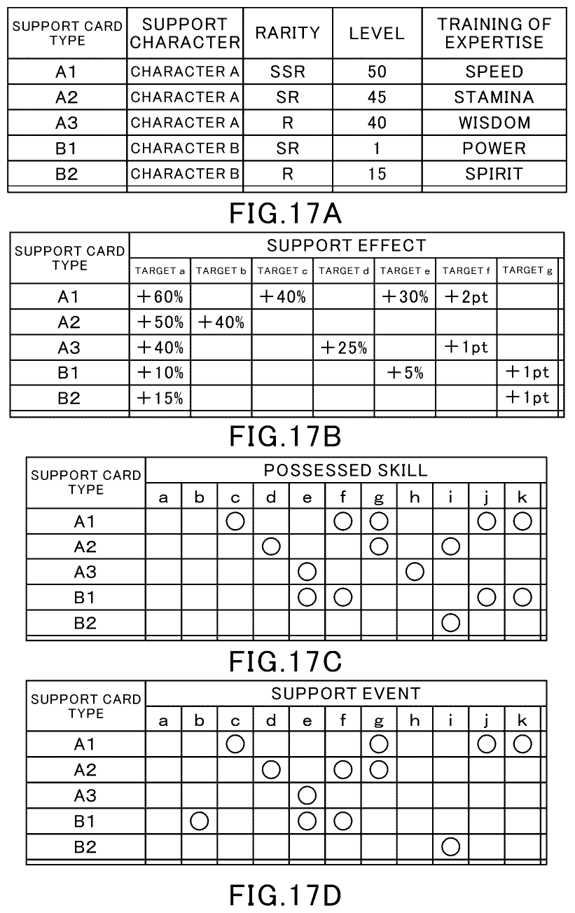

FIG. 17A is a view for explaining a support card table. As shown in FIG. 17A, the support card table stores, for each type (that is, support card ID) of a support card possessed by the player, the kind (that is, character ID) of a support character, the rarity, the level, and training of expertise. The support character corresponds one-to-one to the type of the support card. That is, one character ID is always linked to one support card ID. In other words, one support character is always made to correspond to one support card.

In this embodiment, the rarity is set for each support card. Three stages, i.e., R (rare), SR (super rare), and SSR (super special rare), are provided for the rarity. Note that R is set as the lowest rarity, and SSR is set as the highest rarity. In this embodiment, a support card having a higher rarity tends to have a higher support effect, to be described later. Furthermore, in this embodiment, a support card having a higher rarity tends to have a larger number of possessed skills and a larger number of support events, to be described later.

As the levels of a support card, 50 stages from level 1 to level 50 are provided. The level of a support card can be raised by the player, and the level raised by the player is stored for each support card. Note that the level of a support card can be raised by using the in-game currency, an item, or the like. Note that an upper limit is provided for the level of a support card depending on the rarity thereof.

For example, level 20 is set as the upper limit for a support card that has the rarity R, level 25 is set as the upper limit for a support card that has the rarity SR, and level 30 is set as the upper limit for a support card that has the rarity SSR.

Note that the upper limit of the level can be raised in stages in the case where a predetermined condition is established. For example, it is also possible that the upper limit can be raised up to level 40 for a support card that has the rarity R, the upper limit can be raised up to level 45 for a support card that has the rarity SR, and the upper limit can be raised up to level 50 for a support card that has the rarity SSR.

FIG. 17B is a view for explaining a support effect table. As shown in FIG. 17B, the support effect table stores support effects for each type of a support card possessed by the player.

The support effects raise various statuses in the nurture main game. A plurality of support-effect targets are provided for each support card. Examples of the support-effect targets are physical strength, speed, stamina, power, spirit, wisdom, etc.

FIG. 17C is a view for explaining a possessed-skill table. As shown in FIG. 17C, a possessed skill(s) is set for each of the support cards possessed by the player, in the possessed-skill table. In this embodiment, a possessed skill(s) is set for each support card such that a character that is set as the nurture-target character by the player possesses the possessed skill(s). A possessed skill set for each support card can be obtained by the nurture-target character, which is selected by the player, when a tip event occurs during the nurture main game.

FIG. 17D is a view for explaining a support event table. As shown in FIG. 17D, in the support event table, a support event(s) that could occur is stored for each of the support cards possessed by the player. The support event is an event that could occur during the execution of the nurture main game. In the case where a support event occurs, the values of various statuses in the nurture main game are increased or decreased, in some cases.

For example, a support event that is to occur may be determined according to the number of turns or may be determined by a predetermined lottery. Furthermore, a plurality of support events that are to occur may be selected in one turn. In any case, a support event that is to occur just needs to be determined according to a predetermined determination method set in advance.

Note that support events may include: a first tip event that could occur at the start of a turn in the nurture game; a second tip event that could occur after execution of training, to be described later, in the nurture game; a first ability event that could occur at the start of a turn in the nurture game; a second ability event that could occur after execution of training in the nurture game; etc. The first tip event and the second tip event are events for allowing skills to be possessed or obtained. Furthermore, the first ability event and the second ability event are events for increasing or decreasing the values of the ability parameters of the character. Hereinafter, the first tip event and the first ability event are collectively referred to as a first event(s) and the second tip event and the second ability event are collectively referred to as a second event(s).

FIG. 16C is a second view for explaining the support-card organization screen 190. In this embodiment, when six support cards are all selected, the start operation section 193 can be operated, as shown in FIG. 16C. On the other hand, in the case where six support cards have not all been selected, the start operation section 193 cannot be operated, as shown in FIG. 16A.

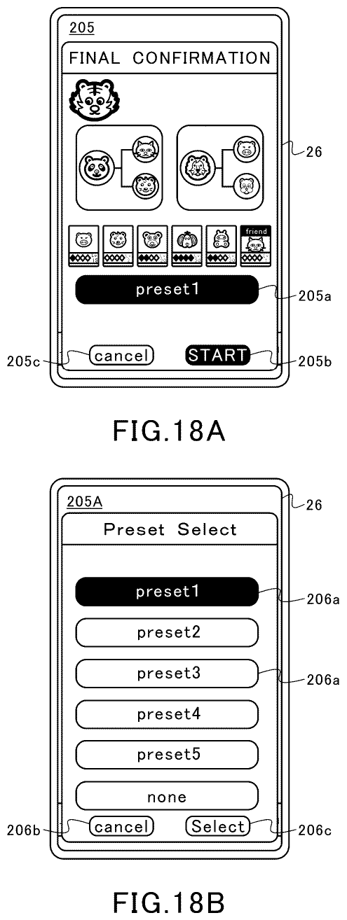

Note that, when the return operation section 153 is operated in the support-card organization screen 190, the inheritance character selection screen 170 shown in FIG. 7D is displayed on the display 26. Furthermore, as shown in FIG. 16C, when the start operation section 193 is tapped in the support-card organization screen 190, the selected support cards are temporarily registered, and a final confirmation screen 205 (FIG. 18A) is displayed.

FIG. 18A is a view for explaining the final confirmation screen 205. FIG. 18B is a view for explaining a preset selection screen 205A. In the final confirmation screen 205, the nurture-target character selected by the player, the nurtured characters that constitute the first inheritance group, the nurtured characters that constitute the second inheritance group, and the support cards are displayed. Furthermore, a preset display section 205a is displayed in the final confirmation screen 205. The number of a preset that is currently selected is shown in the preset display section 205a.

Here, a preset is reservation information on a race in which the nurture-target character is made to participate, in the nurture main game. The player can select an arbitrary race from among all races, to generate a preset. A plurality of presets can be stored, and, in the final confirmation screen 205, it is possible to select one from among the stored presets. Specifically, when the preset display section 205a is tapped, the preset selection screen 205A, which is shown in FIG. 18B, is displayed.

In the preset selection screen 205A, preset read buttons 206a corresponding to the stored presets are displayed. The player can set a preset by tapping any of the preset read buttons 206a and then tapping a selection operation section 206c. Note that, when the selection operation section 206c is tapped, the preset selection screen 205A is closed, and the final confirmation screen 205 is displayed. Furthermore, when a cancel operation section 206b in the preset selection screen 205A is tapped, the preset selection screen 205A is displayed without changing the preset.

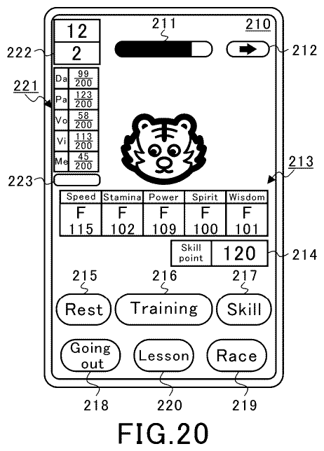

Note that, when a cancel operation section 205c is tapped in the final confirmation screen 205, the support-card organization screen 190 is displayed. On the other hand, when a start operation section 205b is tapped, a game screen 210 (FIG. 20A) is displayed on the display 26.

Note that, in this embodiment, when support cards are registered, limitation is provided such that the character type that is set as the nurture-target character and the character type that is set as a support character do not overlap.

As described above, when the nurture-target character, the inheritance characters, and the support cards have been registered, the preparatory-stage processing ends.

### <Nurture-Stage Processing>

When the preparatory-stage processing ends, the nurture-stage processing is started. Through the nurture-stage processing, the nurture main game, in which the nurture-target character can be nurtured, is progressed. Note that, for ease of understanding, the basic flow of the nurture main game will be first described below.

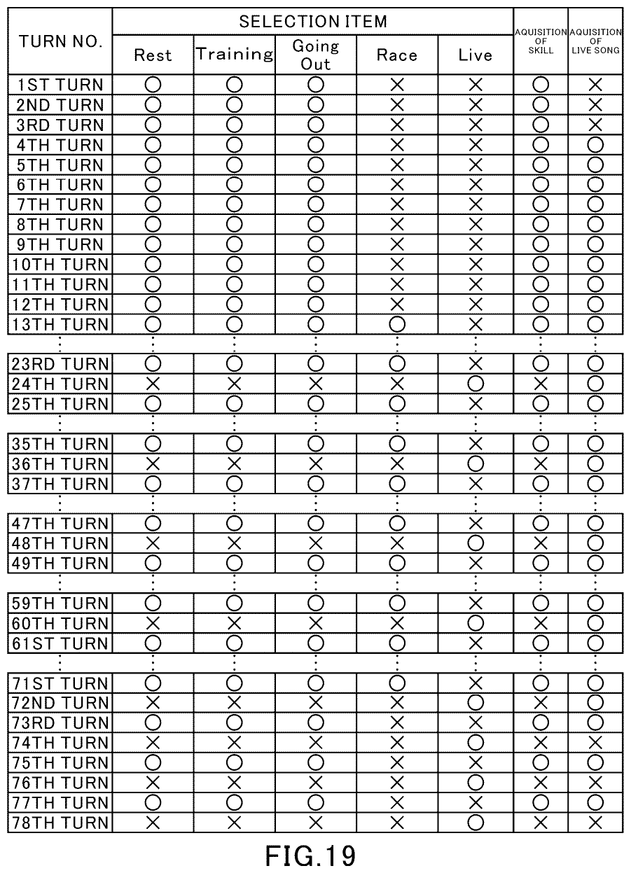

FIG. 19 is a view for explaining selection items in each turn. Note that, here, selection items that can be selected in each turn are common irrespective of the type of the nurture-target character. However, selection items that can be selected in each turn may be different depending on the type of the nurture-target character. The nurture main game is composed of turns from the 1st turn to the 78th turn, as shown in FIG. 19. The various parameters are updated in accordance with a selection item selected by the player in each of the turns.

FIG. 20 is a view for explaining the game screen 210. When a transition is made to the nurture-stage processing, the game screen 210, which is shown in FIG. 20, is displayed on the display 26. A physical-strength display section 211 and a physical-condition display section 212 are displayed at an upper section of the game screen 210. A parameter of “physical strength” is provided for the nurture-target character. The parameter of “physical strength” is mainly used to calculate a failure rate that is the possibility of failing in training, to be described later. The physical-strength display section 211 is displayed such that the current remaining amount of “physical strength” of the nurture-target character with respect to the upper limit of “physical strength” can be visually grasped.

Furthermore, a parameter of “physical condition” is provided for the nurture-target character. The physical-condition display section 212 is displayed such that the current “physical condition” of the nurture-target character can be visually grasped by a plurality of stages (five stages of very bad condition, bad condition, normal condition, good condition, and very good condition). As the parameter of “physical condition” becomes higher, the race development becomes advantageous to the nurture-target character, and the increase values for the ability parameters due to training become higher.

Furthermore, the image of the nurture-target character, a status display section 213, and a skill-point display section 214 are displayed at a central section of the game screen 210, as shown in FIG. 20. In the status display section 213, the current statuses of the nurture-target character are shown by numerical values and ranks in a plurality of stages (18 stages of G, G+, F, F+, E, E+, D, D+, C, C+, B, B+, A, A+, S, S+, SS, and SS+).

Specifically, in this embodiment, the values and the ranks of the ability parameters of “Speed” (speed), “Stamina” (stamina), “Power” (power), “Spirit” (spirit), and “Wisdom” (wisdom) are displayed. Furthermore, in the skill-point display section 214, the remaining amount of the skill points possessed by the nurture-target character in the nurture game is numerically shown.

Furthermore, as shown in FIG. 20, a rest operation section 215, in which “Rest” is written, a training operation section 216, in which “Training” is written, a skill operation section 217, in which “Skill” is written, a going-out operation section 218, in which “Going Out” is written, a race operation section 219, in which “Race” is written, and a live-preparation operation section 220, in which “Lesson” is written, are displayed at a lower section of the game screen 210.

When the rest operation section 215 is selected, a rest event occurs, and the physical strength is restored. When the training operation section 216 is selected, training, to be described later, can be executed. When the skill operation section 217 is selected, a skill can be obtained. When the going-out operation section 218 is selected, a going-out event occurs, and the physical condition is mainly increased.

When the race operation section 219 is selected, the nurture-target character can be made to participate in a race. When a race is executed, rewards, such as the in-game currency, fans, etc., are given in accordance with the order of arrival of the nurture-target character in the race. At this time, the rewards to be obtained are increased as the order of arrival is higher. Furthermore, more rewards can be obtained as the difficulty level of a race is higher. For example, more rewards can be obtained in a race of a higher grade among the grades of GI, GII, and GIII.

When the live-preparation operation section 220 is selected, a live song or a live skill (hereinafter, referred to as live song or the like) to be performed in a live event, to be described later, can be obtained. Hereinafter, the operation sections from the rest operation section 215 to the live-preparation operation section 220 are referred to as commands. Furthermore, processing procedures or events themselves executed on the basis of operations on the rest operation section 215 to the live-preparation operation section 220 are referred to as commands, in some cases.

Note that, when occurrence of a rest event, occurrence of a going-out event, execution of training, or participation in a race is performed, the current turn ends, and a transition is made to the next turn. On the other hand, when acquisition of a skill or acquisition of a live song or the like is performed, the current turn does not end, and another command can be further selected.

In FIG. 19, a single circle is put for commands that can be selected by the player in each turn, and a cross is put for commands that cannot be selected by the player in each turn. Note that the commands that can be selected by the player in each turn, which are shown in FIG. 19, are merely examples. Here, in this embodiment, a 24th turn, a 36th turn, a 48th turn, a 60th turn, a 72nd turn, a 74th turn, a 76th turn, and a 78th turn are set as live holding turns. In the live holding turns, live events, indicated by “Live” in FIG. 19, occur. Then, in the live holding turns, a command that can be selected by the player is limited to execution of a live event or acquisition of a live song or the like.

However, in the live holding turns, it is also possible that a command(s) other than execution of a live event and acquisition of a live song or the like can be selected. In this case, for example, after a command for ending the current turn is selected, and a predetermined event occurs, a live event may be executed.

As will be described in detail later, in this embodiment, a live event is executed on the basis of a live song(s) or the like obtained before the live holding turn. The nurture-target character obtains, through execution of training, parameters for individual performances (hereinafter, referred to as performance parameters), to be described later. A live song or the like can be obtained by consuming the performance parameters possessed by the nurture-target character. When a live event is executed, a reward is given to the player. A reward to be given to the player becomes advantageous as the number of live songs or the like obtained before the live event is executed is larger.

Note that, during the nurture main game, the player can confirm live songs or the like obtained before a next live event is executed, in various screens. However, when the live event is executed, the number of live songs or the like obtained before a next live event, i.e., the number of currently obtained live songs or the like, becomes 0. Therefore, the player needs to appropriately obtain live songs or the like during the period from the start of the nurture main game to the first live holding turn or during periods between the live holding turns.

As shown in FIG. 20, a performance-parameter display section 221, a turn display section 222, and an acquisition-status display icon 223 are provided at an upper left section of the game screen 210. In the performance-parameter display section 221, the values of the performance parameters possessed by the nurture-target character are displayed. In this embodiment, five kinds of performance items of dance, passion, vocal, visual, and mental are provided. Then, the parameter is provided for each of the performance items.

Da, Pa, Vo, Vi, and Me displayed in the performance-parameter display section 221 indicate performance items of dance, passion, vocal, visual, and mental, respectively. In the performance-parameter display section 221, an upper limit of the parameter of each of the performance items is shown in the bottom, and the current value thereof is shown in the top. Note that the upper limit of the parameter of each of the performance items is increased in each of the live holding turns. For example, the upper limits of the parameters of all the performance items are set to 200 before the first live holding turn. Therefore, during the period before the 24th turn, which is the first live holding turn, the performance parameters increase or decrease within the range of 200 or less. Then, when the 24th turn ends, the upper limits of the parameters of the performance items are increased to 300, for example.

In this way, in this embodiment, the upper limits of the parameters of the performance items are increased in stages. Accordingly, the player is required to frequently obtain a live song or the like.

Furthermore, in the turn display section 222, the number of remaining turns before the next live holding turn and the number of the current turn after the start of the nurture main game are displayed. Furthermore, when the acquisition-status display icon 223 is tapped, an acquisition-status display screen (not shown) is displayed. In the acquisition-status display screen, songs that have been obtained after the previous live holding turn and that will be performed at the next live event are displayed in a list. Furthermore, in the acquisition-status display screen, all live songs or the like that have been obtained after the start of the nurture main game can be confirmed.

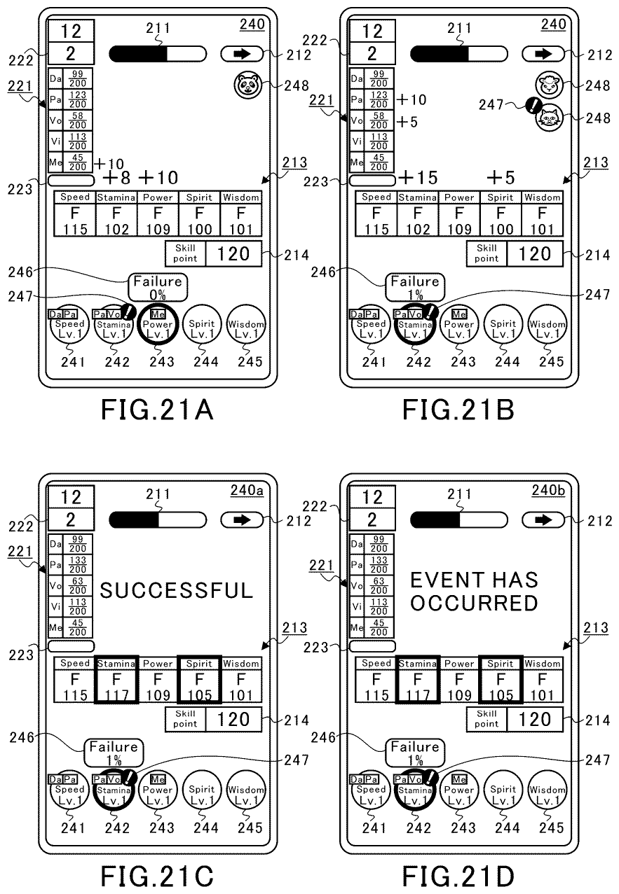

FIG. 21A is a first view for explaining a training screen 240. FIG. 21B is a second view for explaining the training screen 240. When the training operation section 216 in the game screen 210 is operated, the training screen 240 is displayed on the display 26.

As shown in FIG. 21A, a status display section 213, and a skill-point display section 214 are displayed near a central section of the training screen 240. Furthermore, the performance-parameter display section 221, the turn display section 222, and the acquisition-status display icon 223 are displayed at an upper left section of the training screen 240. Furthermore, training items are displayed at a lower section of the training screen 240. Here, a speed operation section 241, in which “Speed” is written, a stamina operation section 242, in which “Stamina” is written, a power operation section 243, in which “Power” is written, a spirit operation section 244, in which “Spirit” is written, and a wisdom operation section 245, in which “Wisdom” is written, are displayed.

When the player taps any of the operation sections 241 to 245 once, the training item corresponding to the tapped one of the operation sections 241 to 245 is temporarily selected. At this time, the one of the operation sections 241 to 245 corresponding to the temporarily selected training item is highlighted. FIG. 21A shows a state in which the power operation section 243 is temporarily selected. Furthermore, FIG. 21B shows a state in which the stamina operation section 242 is temporarily selected.

Furthermore, in each of the operation sections 241 to 245, the training level of the corresponding training item is also displayed. The training level is a parameter that is increased in accordance with the number of times to select the corresponding training item. Increase values for the ability parameters when training is executed are increased as the training level is higher. The training level is initially set to level 1 and is increased up to level 5.

Furthermore, for the temporarily selected one of the operation sections 241 to 245, a failure-rate display section 246, in which “Failure” is written, is displayed. The failure rate numerically displayed in the failure-rate display section 246 is set so as to increase in reverse proportion to the remaining amount of the physical strength, which is displayed in the physical-strength display section 211.

Furthermore, the values by which the ability parameters are increased in the case where the temporarily selected training is executed successfully are displayed in the status display section 213. For example, in the example case shown in FIG. 21A, the power operation section 243 is temporarily selected, and “+8” and “+10” are displayed for “Stamina” and “Power”, respectively, in the status display section 213. Furthermore, in the example case shown in FIG. 21B, the stamina operation section 242 is temporarily selected, and “+15” and “+5” are displayed for “Stamina” and “Spirit”, respectively, in the status display section 213.

Furthermore, an event notification display 247 is displayed on any of the operation sections 241 to 245 that corresponds to the training item for which a predetermined event occurs, in the case where the training is executed successfully. Note that the display mode of the event notification display 247 can be different depending on the type of an event.

Furthermore, as shown in FIG. 21B, at an upper right section of the training screen 240, arranged-character icons 248 corresponding to characters arranged for the temporarily selected training are displayed. Then, in the case where the training is successful, a predetermined event occurs for any of the characters displayed in the arranged-character icons 248, in some cases. In this case, the event notification display 247 is displayed on the corresponding arranged-character icon 248.

In this embodiment, characters to be arranged for training include support characters. When training for which a support character has been arranged is executed, a second event linked to the arranged support character occurs in some cases. In the case where this second event occurs, the event notification display 247 is displayed on the arranged-character icon 248. In the case where training for which a support character has been arranged is successful, increase values for the parameters of the nurture-target character become higher than those in the case where training for which a support character is not arranged is successful.

Note that characters to be arranged for training include a character other than the support characters corresponding to the support cards registered by the player in the preparatory-stage processing. For example, from among all support characters implemented in the game, a character selected by a random lottery could be arranged for training. In this case, a character icon 248 indicating a character other than the support characters registered by the player is displayed in the training screen 240.

Furthermore, when training for which the character icon 248 has been displayed is executed, an event linked to a character other than the support characters registered by the player may occur. Here, the occurrence rate of an event linked to a character that is not registered by the player is lower than the occurrence rate of an event linked to any of the support characters that have been registered by the player. In this case, the event notification display 247 may also be displayed on the character icon 248 displayed in the training screen 240.

FIG. 21C is a view for explaining a training-result notification screen 240a. When the one of the operation sections 241 to 245 that is temporarily selected is tapped again, the training corresponding to the tapped one of the operation sections 241 to 245 is executed. When the training is executed, the training-result notification screen 240a, in which success or failure of the training is notified, is displayed on the display 26. Here, a word “success” is displayed, whereby success of the training is notified to the player.

Furthermore, at this time, the ability parameters in the status display section 213 are updated and displayed on the basis of the success of the training. That is, the ability parameters (ability information) of the nurture-target character that correspond to the training item (nurture item) selected by the player are updated.

Here, the values by which the ability parameters are increased in the case where the training is successful are added, the values being displayed in the status display section 213 in FIG. 21A or FIG. 21B. Furthermore, the display of the physical-strength display section 211 is updated according to the executed training item. In the case where any training of speed, stamina, power, or spirit is executed successfully, the physical strength is reduced. On the other hand, in the case where training of wisdom is executed successfully, the physical strength is restored.

Furthermore, in the case where training is failed, a predetermined penalty is given. Specifically, examples of the content of a penalty include a reduction in the physical strength, reductions in the values of the ability parameters, a decrease in the physical condition, etc. Note that it is possible that, for example, a penalty given when the failure rate is high is more disadvantageous (for example, the value by which the physical strength is reduced is larger, the values by which the ability parameters are reduced are larger, or the number of stages by which the physical condition is decreased is larger) than a penalty given when the failure rate is low.

Furthermore, the content of a penalty may be determined depending on the training item. For example, the value of the ability parameter of speed may be reduced in the case where training of speed is failed, and the value of the ability parameter of power may be reduced in the case where training of power is failed. Furthermore, it is possible that a penalty is not given even when training of part (for example, wisdom) of the training items is failed.

Here, in this embodiment, a performance item is linked to each training item at a predetermined rate. For example, at the start of a turn, a performance item(s) to be linked to each training item is determined by a lottery. Here, up to two performance items are linked to one training item. As shown in FIGS. 21A and 21B, performance items linked to training items are displayed in an identifiable manner on the speed operation section 241 to the wisdom operation section 245.

Specifically, in the example shown in FIG. 21A, two performance items of dance and passion are linked to the training item of speed. In this case, “Da” indicating dance and “Pa” indicating passion are noted on the speed operation section 241. Similarly, performance items of passion and vocal are linked to the stamina operation section 242. Furthermore, a performance item of mental is linked to the power operation section 243. On the other hand, no performance item is linked to the training items of spirit and wisdom. However, it is also possible that one or more performance items are always linked to all the training items in every turn. Furthermore, it is also possible that the identical performance item is linked to two or more different training items.

Then, it is assumed that a training item is selected, and the training is successful. At this time, in the case where a performance item has been linked to the successful training, the parameter of this linked performance item is increased. As described above, in the example shown in FIG. 21A, the performance item of mental is linked to the training item of power. In a state in which the training item of power is temporarily selected, “+10” is noted at the right side of the display section of mental in the performance-parameter display section 221. This indicates that the performance parameter of mental is increased by 10 in the case where the training of power is successful.

Similarly, in the example shown in FIG. 21B, it is indicated that, in the case where the training of stamina is successful, the performance parameter of passion is increased by 10, and the performance parameter of vocal is increased by 5. In this way, in a state in which any of the training items is temporarily selected, the value(s) by which the performance parameter(s) is increased when the temporarily selected training is successful is displayed in the performance-parameter display section 221.

Then, when the training item is determined, and the corresponding training is successful, the corresponding performance parameter(s) is increased. FIG. 21C shows a case in which the training of stamina has been successful. Here, as is apparent when comparing between FIG. 21B and FIG. 21C, in the performance-parameter display section 221, the performance parameter of passion is increased by 10, and the performance parameter of vocal is increased by 5. Note that increase values for the performance parameters will be described later.

FIG. 21D is a view for explaining an event screen 240b. When display of the training-result notification screen 240a ends, the event screen 240b is displayed on the display 26 in some cases. In the event screen 240b, various events are executed. Note that a plurality of events occur during one turn, in some cases.

For example, in the case where the first tip event or the second tip event occurs, a tip for a skill can be obtained. When a tip for a skill is obtained, the player can obtain the skill by consuming the skill points. A plurality of kinds of skills are provided, and a predetermined ability is activated for each skill in some cases. An activation condition and an effect are defined for each of the skills, and, in the case where an individual activation condition is established, a predetermined effect is activated. A skill is activated during a race, to be described later, in some cases.

Examples of the events include, in addition to the first tip event and the second tip event for possessing skills, an event for restoring the physical strength, an event for reducing the physical strength, a first ability event and a second ability event for increasing or decreasing the ability parameters, an event for increasing the physical condition, an event for reducing the physical condition, etc. Although a detailed description will be given later, there are an event that occurs in a predetermined turn and an event that occurs when a predetermined lottery is won. Furthermore, there are an event that occurs at the start of a turn and an event that occurs before the end of a turn. When an event(s) that has occurred is all finished, the game screen 210 related to the next turn is displayed.

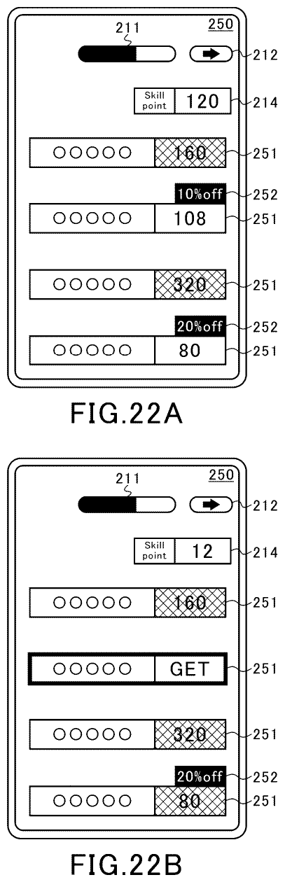

FIG. 22A is a first view for explaining a skill screen 250. FIG. 22B is a second view for explaining the skill screen 250. When the skill operation section 217 in the game screen 210 is operated, the skill screen 250 shown in FIG. 22A is displayed on the display 26.

In the skill screen 250, skill display fields 251 are displayed. In the skill display fields 251, obtained skills, possessed skills that have been set in advance for the nurture-target character, possessed skills that have been possessed due to the occurrence of various events, etc., are displayed. Furthermore, in the case where a first tip event or a second tip event occurs for any of the possessed skills, skill points to be consumed to obtain this possessed skill are discounted. Here, for the possessed skill for which a tip is obtained, skill points required to obtain this possessed skill are discounted, and the resultant is displayed. At this time, a discount-rate display icon 252 indicating a discount rate is displayed together with the corresponding skill display field 251.

Furthermore, for each of the skills displayed in the skill screen 250, an activation condition for the skill and an effect to be exerted when the skill is activated are displayed. When the possessed skill is obtained by consuming the skill points on the basis of an operation of the player, “GET” is displayed for the obtained skill, as shown in FIG. 22B, to notify that the possessed skill has been obtained, and the consumed skill points are subtracted from the skill points displayed in the skill-point display section 214, whereby the display of the skill points is updated.

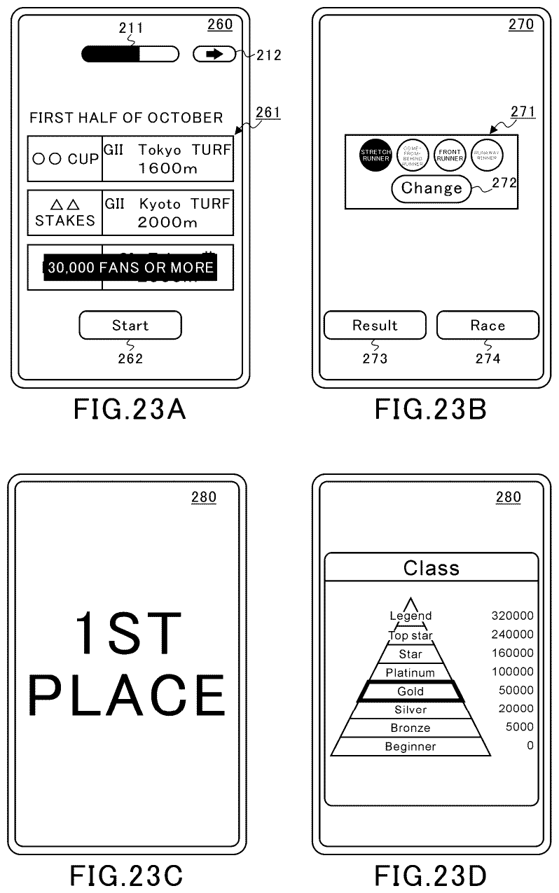

FIG. 23A is a first view for explaining a race selection screen 260. When the race operation section 219 in the game screen 210 is operated, the race selection screen 260, which is shown in FIG. 23A, is displayed. The race has a game property in which the nurture-target character and NPCs participate in the race.

At an upper section of the race selection screen 260, the physical-strength display section 211 and the physical-condition display section 212 are displayed. Furthermore, a race selection operation section 261 for selecting a race event in which the nurture-target character is made to participate is displayed at a central section of the race selection screen 260. A plurality of race selection operation sections 261 could be displayed in the race selection screen 260. Furthermore, a start operation section 262, in which “Start” is written, is displayed at a lower section of the race selection screen 260. Note that a race (s) that can be selected by means of the race selection operation section(s) 261 in the race selection screen 260 is set in advance for each turn.

Furthermore, a participation condition is set in advance for each race, and the player can make the nurture-target character participate only in a race for which the participation condition is satisfied. As described above, for some races, the number of fans is prescribed as the participation condition. For a race for which a prescribed number of fans has not been satisfied, the participation condition is displayed on the corresponding race selection operation section 261, as shown in FIG. 23A, to notify that this race cannot be selected.

FIG. 23B is a view for explaining a race start screen 270. When the start operation section 262 is operated with a race event of a race for participation being selected by means of the corresponding race selection operation section 261, the race start screen 270, which is shown in FIG. 23B, is displayed. A strategy display section 271 is displayed at a central section of the race start screen 270. Furthermore, in the strategy display section 271, a currently selected strategy (stretch runner, come-from-behind runner, front runner, or runaway winner) is highlighted, and a change operation section 272, in which “Change” is written, is displayed. When the change operation section 272 is operated, a strategy change screen (not shown) is displayed on the display 26. The player can change the strategy for the race to an arbitrary strategy, through an operation performed in the strategy change screen.

Furthermore, a result operation section 273, in which “Result” is written, and a race operation section 274, in which “Race” is written, are displayed at a lower section of the race start screen 270.

In the case where the race operation section 274 is operated, a race screen (not shown) is displayed on the display 26. A video of the race development (hereinafter, also referred to as a race video) is displayed on the display 26.

FIG. 23C is a first view for explaining a race result screen 280. FIG. 23D is a second view for explaining the race result screen 280. In the case where playback of the above-described race video is finished, and, in the case where the result operation section 273 is operated, the race result screen 280 is displayed on the display 26. In the race result screen 280, the order of arrival of the nurture-target character in this race is displayed, as shown in FIG. 23C. Furthermore, the current class of the nurture-target character is displayed in the race result screen 280, as shown in FIG. 23D.

In this embodiment, the nurture-target character is set in a class according to the number of obtained fans. The range of the number of fans is set in each class, and, here, the nurture-target character is classified into one of eight stages according to the number of fans. In the race result screen 280, the number of fans obtained in the current race is displayed. Furthermore, in the race result screen 280, the total number of fans, which is obtained by adding the number of newly obtained fans to the number of already obtained fans, is displayed. Furthermore, the current class corresponding to the total number of fans is displayed in an identifiable manner.

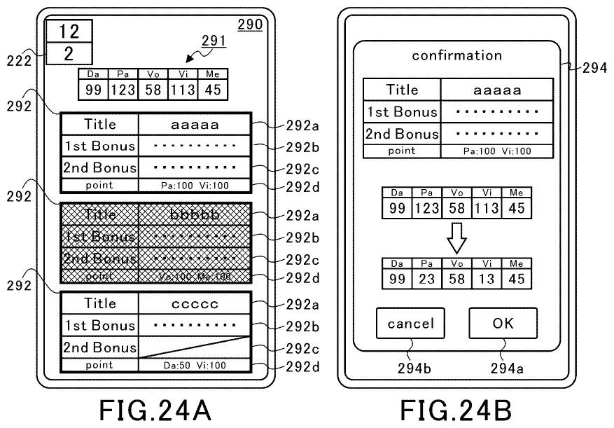

FIG. 24A is a view for explaining an example of a live preparation screen 290. When the live-preparation operation section 220 in the game screen 210 is operated, the live preparation screen 290, which is shown in FIG. 24A, is displayed. The live preparation screen 290 is a screen in which a live song or the like is obtained by consuming the performance parameters. At an upper section of the live preparation screen 290, a performance-parameter display section 291 is displayed. In the performance-parameter display section 291, the current parameter value is displayed for each of the five kinds of performance items.

In the live preparation screen 290, three live songs or the like that can be obtained by the player are presented. At a lower section of the performance-parameter display section 291, live-song detail display fields 292 are displayed for the live songs or the like. That is, three live-song detail display fields 292 are always displayed in the live preparation screen 290. Different live songs or the like are linked to the three live-song detail display fields 292. By tapping any of the live-song detail display fields 292, the player can obtain the live song or the like linked to the live-song detail display field 292.

Each of the live-song detail display fields 292 includes a title display field 292a, a first-bonus display field 292b, a second-bonus display field 292c, and a consumption-parameter display field 292d. In the title display field 292a, a title name of a live song or the like is displayed. The content of a first bonus is written in the first-bonus display field 292b, and the content of a second bonus is written in the second-bonus display field 292c. In the consumption-parameter display field 292d, the performance parameters that are consumed to obtain the live song or the like, in other words, the performance parameters that are required to obtain the live song or the like, are written.

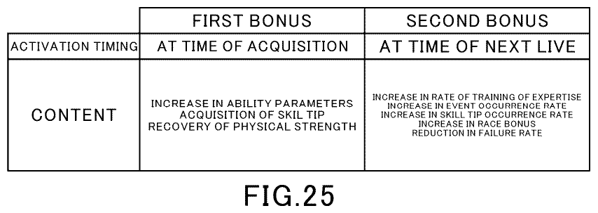

FIG. 25 is a view for explaining examples of the first bonus and the second bonus. The first bonus is always linked to a live song or the like. The first bonus brings benefits advantageous to the player. The first bonus brings, for example, benefits such as increases in the ability parameters, acquisition of a tip for a skill, and restoration of the physical strength.

Furthermore, depending on the live song or the like, the second bonus is linked thereto, in addition to the first bonus. Specifically, a live skill to which only the first bonus is linked and a live song to which both the first bonus and the second bonus are linked are provided. Similarly to the first bonus, the second bonus also brings benefits advantageous to the player. The second bonus brings, for example, benefits such as an increase in the possibility of a character to be arranged for training of expertise (the rate of training of expertise), an increase in the occurrence rate of an event, an increase in the occurrence rate of a tip for a skill, an increase in a reward (race bonus) to be obtained in a race, and a reduction in the failure rate.

Here, the first bonus and the second bonus have different activation timings for the benefits. In other words, the first bonus and the second bonus have different timings at which the benefits are brought. The benefits of the first bonus occur in a turn in which the player obtains a live song or the like. In contrast to this, the benefits of the second bonus occur in a particular turn set in advance, after the turn in which the player obtains the live song or the like. Specifically, the benefits of the second bonus occur at the time of the next live event, i.e., in the next live holding turn.

In the first-bonus display field 292b and the second-bonus display field 292c, which are shown in FIG. 24A, benefits that are to occur are shown as the content of the first bonus and the content of the second bonus. Note that, in FIG. 24A, the second-bonus display field 292c of the live-song detail display field 292 that is displayed at the bottom is in blank. This indicates that the second bonus is not linked to this live song or the like.

Furthermore, in the case where the performance parameters that are required to obtain a live song or the like are insufficient, it is impossible to obtain the live song or the like displayed in the live preparation screen 290. For a live song or the like that cannot be obtained due to lack of the performance parameters, the live-song detail display field 292 is grayed out. In the example shown in FIG. 24A, the live songs or the like corresponding to the live-song detail display fields 292 that are displayed at the top and the bottom can be obtained, and the live song or the like corresponding to the live-song detail display field 292 that is displayed at the middle cannot be obtained.

FIG. 24B is a view for explaining a confirmation dialog 294. When the live-song detail display field 292 corresponding to a live song or the like that can be obtained is tapped, the confirmation dialog 294, which is shown in FIG. 24B, is displayed. In the confirmation dialog 294, the same information as in the live-song detail display field 292 tapped by the player is displayed. Furthermore, the current performance parameters and the remaining performance parameters when the corresponding live song or the like is obtained are displayed.

Furthermore, an execution button 294a and a cancel button 294b are provided in the confirmation dialog 294. When the cancel button 294b is tapped, the confirmation dialog 294 is closed, and the live preparation screen 290 is displayed. When the execution button 294a is tapped, the live song or the like selected by the player is obtained. When the live song or the like is obtained, the first bonus linked to the obtained live song or the like is activated. Due to the activation of the first bonus, various kinds of the parameters are updated. Although not shown in the figures, the benefits to be brought by the first bonus are notified by productions.

As described above, when the player obtains a live song or the like, three live songs or the like that can be next obtained by the player are newly determined. That is, among the three live songs or the like that have been presented in the live preparation screen 290, the opportunities to obtain the two live songs or the like that were not obtained by the player are lost.

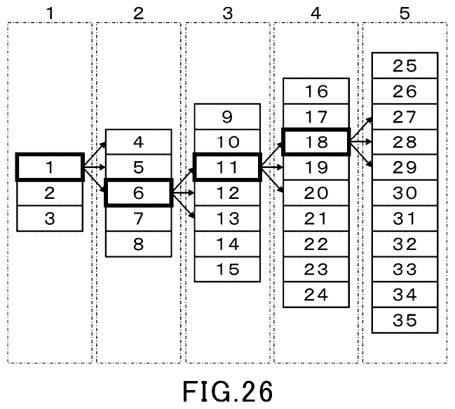

FIG. 26 is a view for explaining an example of live-song route information. Live songs or the like that are presented so as to be obtainable by the player are arranged in a so-called tree structure. For example, it is assumed that three live songs or the like of No. 1, No. 2, and No. 3 are first presented to the player after the start of the nurture main game. Then, in the case where the player obtains the live song or the like of No. 1, three live songs or the like of No. 4, No. 5, and No. 6 are next presented. Then, in the case where the player obtains the live song or the like of No. 6, three live songs or the like of No. 11, No. 12, and No. 13 are next presented. Furthermore, in the case where the player obtains the live song or the like of No. 11, three live songs or the like of No. 18, No. 19, and No. 20 are next presented.

Note that, when the last column of columns shown on the horizontal axis in FIG. 26 is reached, the route may be looped so as to be linked to a predetermined column. Accordingly, the player can obtain a live song or the like irrespective of a limit of the tree structure.

In this way, for each of three live songs or the like that are presented to the player, three live songs or the like to be next presented in an obtainable manner are set in advance. Different benefits are linked to live songs or the like obtained by the player. Therefore, it is an important strategic element for the player to obtain live songs or the like through which route.

Note that, in this embodiment, it is impossible to obtain one live song or the like twice. Thus, display or not of three live songs or the like that can be next obtained by the player may be determined on the basis of whether or not those live songs or the like have already been obtained by the player. For example, a live song(s) or the like that has already been obtained by the player is not displayed, and only live songs or the like that have not yet been obtained by the player are displayed. At this time, a live song or the like that has already been obtained may be replaced with another live song or the like that has not yet been obtained. In this way, a song(s) or the like that has already been obtained is not displayed, whereby it is guaranteed that three obtainable choices are always displayed.

It is also possible to set an upper limit on the number of songs or the like that can be obtained during a particular turn. In this case, it is preferred that display or not of three live songs or the like that can be next obtained by the player is determined on the basis of whether the upper limit number of songs or the like has been obtained during the particular turn. Accordingly, the pace of obtaining songs or the like, from which particularly great benefits are brought, during the game is controlled, whereby it is possible to improve an interest.

Furthermore, the method for determining live songs or the like to be presented to the player is not limited thereto. For example, in the case where the player obtains a live song or the like, a plurality of live songs or the like that can be newly obtained by the player may be determined by a lottery. In this case, for example, three live songs or the like that can be next obtained by the player may be determined by a lottery. Alternatively, it is also possible that either one of the remaining two live songs or the like that were not obtained by the player is reused, and two new live songs or the like are determined by a lottery.

Furthermore, for example, it is also possible to provide three routes, i.e., a first route, a second route, and a third route, in each of which one order of live songs or the like to be presented to the player is defined. In this case, for example, when the player obtains a live song or the like in the first route, a next live song or the like defined in the first route is presented to the player. At this time, live songs or the like in the second route and the third route may be presented as they are, or next live songs or the like therein may be presented to the player as in the first route.

Furthermore, here, the player can obtain only one of the presented three live songs or the like. However, it is also possible that the player can obtain a part or some of the presented three live songs or the like.

When the player obtains a live song or the like, the live-song detail display fields 292 corresponding to new live songs or the like are displayed in the live preparation screen 290. Therefore, the player can obtain a plurality of live songs or the like during one turn.

Furthermore, here, three choices that can be selected by the player are all live songs or the like. However, the three choices that can be selected by the player may include, in addition to a live song or the like, a first bonus or a second bonus that is not linked to the live song or the like. For example, it is possible that, in FIG. 26, No. 1 indicates a first bonus, No. 2 indicates a second bonus, and No. 3 indicates a live song or the like. In this case, when No. 2 is selected, the second bonus is given to the player, and choices of No. 5, No. 6, and No. 7 are newly presented.

Furthermore, here, a fixed first bonus and a fixed second bonus are linked to each live song or the like. However, for example, a first bonus group or a second bonus group may be linked to each live song or the like. In this case, the winning rate(s) of one or a plurality of benefits is set in advance for each of the first bonus group and the second bonus group. Then, a benefit to be given may be determined by a lottery on the basis of the first bonus group or the second bonus group linked to a live song or the like obtained by the player.

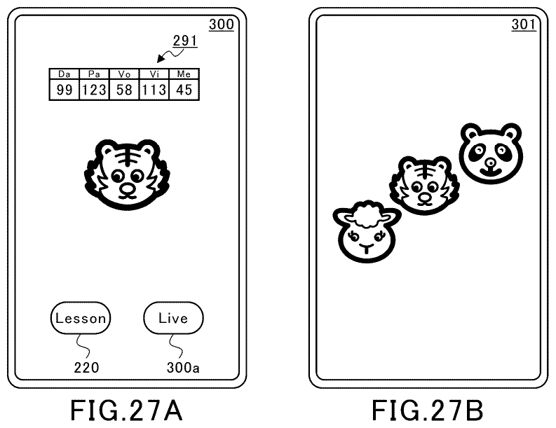

FIG. 27A is a view for explaining an example of a live start screen 300. FIG. 27B is a view for explaining an example of a live event screen 301. In a live holding turn, the live start screen 300 is displayed instead of the game screen 210. In the live start screen 300, the performance-parameter display section 291 is displayed. Furthermore, a live-preparation operation section 220 and a live start button 300a are displayed at a lower section of the live start screen 300.

When the live-preparation operation section 220 is tapped in the live start screen 300, the live preparation screen 290, which is shown in FIG. 24A, is displayed. Therefore, in a live holding turn, the player can also obtain a live song or the like. Furthermore, when the live start button 300a is tapped, the live event screen 301, which is shown in FIG. 27B, is displayed.

A cut-in image in which a plurality of characters are displayed is included in the live event screen 301. In the live event screen 301, an image in which the nurture-target character etc. perform live is displayed. Note that the number of characters displayed in the live event screen 301 is, for example, one, three, or five. At this time, for example, the number of characters displayed in the live event screen 301 may be increased as the number of live songs or the like obtained between live holding turns is increased. Alternatively, the number of characters displayed in the live event screen 301 may be fixed.

Furthermore, here, in the live event screen 301, a cut-in image is just displayed, and an actual live video is not displayed. However, it is also possible to output a live video that corresponds to an actually obtained live song(s) or the like. Alternatively, it is also possible to output only a live video that corresponds to a part of the obtained live song(s) or the like.

Furthermore, as will be described in detail later, this embodiment has a specification in which a live cooperation member(s) is determined in a turn set in advance. Therefore, a reward to be given after a live event may be different depending on the number of live cooperation members or the kinds of characters. Specifically, in predetermined turns, a character that is set in advance becomes a live cooperation member, and a character that is won by a lottery becomes a live cooperation member. That is, as the player proceeds with turns, the number of live cooperation members is gradually increased. At this time, a character(s) to be displayed in the live event screen 301 may be determined by a lottery or the like from among the live cooperation members. In this case, the display mode of the live event screen 301 change according to the progress of the nurture main game, whereby an interest of the game is improved.

Furthermore, a reward to be given after a live event may become advantageous as the number of live songs or the like obtained by the player from the previous live event to the current live event is increased. For example, in the case where the number of live songs or the like obtained by the player is smaller than a predetermined number, a live event is successful, and a predetermined reward is given. On the other hand, in the case where the number of live songs or the like obtained by the player is equal to or larger than the predetermined number, a live event is greatly successful, and a more advantageous reward than that given in a successful live event is given.

Note that, in this embodiment, even in the case where no live song or the like is obtained, it is judged that a live event is successful. In this case, for example, it is possible to provide a story in which a fixed live song or the like is performed in a live event. However, in a live holding turn, in the case where no live song or the like has been obtained, it may be judged that a live event is unsuccessful or the game may be over.

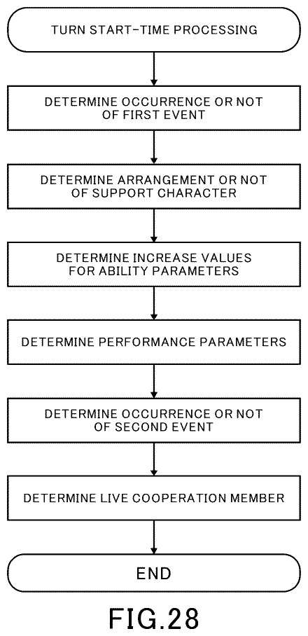

FIG. 28 is a view for explaining a rough flow of turn start-time processing. The nurture-stage processing includes the turn start-time processing, which is executed at the start of each turn of the nurture game. Although details of the turn start-time processing will be described later, a description will be given here of the rough flow of the turn start-time processing.

During the nurture main game, processing for determining whether to make any of various events appear is executed in each turn. The events are roughly divided into three types of events, i.e., a scenario event, the above-described dedicated events, which are set for each nurture-target character, and the support events. Note that a scenario event, dedicated events, and support events that could appear during the nurture main game are defined in advance in each scenario.

The scenario event is an event set in each scenario of the nurture main game. In this embodiment, a plurality of scenarios are provided, and the player can select any of the scenarios. The scenario event appears in each scenario selected by the player. In other words, a scenario event that appears in the nurture main game is determined on the basis of the scenario selected by the player.

Note that a scenario inherent event and a scenario common event may be provided as scenario events. The scenario inherent event is an event linked to only one scenario. For example, a scenario inherent event that is linked to a first scenario appears only when the first scenario is selected and does not appear when another scenario is selected.

Furthermore, the scenario common event is an event that appears in the plurality of scenarios. Therefore, the scenario common event appears in both cases in which the first scenario is selected and in which a second scenario is selected.

Here, it is assumed that the scenario inherent event and the scenario common event are provided as scenario events. However, it is also possible that only one of the scenario inherent event and the scenario common event is provided.

The dedicated events are events set in advance for each character, as described above. In the nurture main game, dedicated events for the character registered as the nurture-target character by the player in the setting game, i.e., in the preparatory-stage processing, appear.

The support events are events set in advance for the individual support cards, as described above. In the nurture main game, support events linked to the support cards registered by the player in the setting game appear. The support events include first events that could occur at the start of a turn and second events that could occur after execution of training. The occurrence or not of a first event is determined at the start of a turn on the basis of a random number that is randomly acquired and a first-event table.

After processing for determining each support character to be arranged for training is performed, the occurrence or not of a second event is determined on the basis of a random number that is randomly acquired and a second-event table. Note that, only in the case where a support character is arranged for training, the occurrence or not of a second event is determined for the arranged support character.

Note that, in this embodiment, it is assumed that a first event is selected by a lottery from among the support events linked to the support cards registered in the deck by the player in the preparatory-stage processing. However, the present invention is not limited thereto, and it is also possible to select a support event linked to a support card selected by a lottery from among all support cards implemented in the game. In this case, it is preferred that the selection rate of a support event linked to a support card that is registered in the deck is higher than the selection rate of a support-card event linked to a support card that is not registered in the deck.

In this way, the appearance or not of the scenario event is determined on the basis of the scenario.

Furthermore, the appearance or not etc. of the dedicated event(s) and that of the support event(s) are determined on the basis of the nurture-target character and the support card(s), respectively. These event types are divided according to information to be referred to when the appearance or not etc. of the event(s) is determined.

In contrast to this, in this embodiment, individual events are each classified into any of six event classifications according to the content brought about by the appearance of the event. Here, individual events are each classified into any of the event classifications, i.e., a first tip event, a second tip event, a first ability event, a second ability event, an aptitude event, and a story event.

As described above, the first tip event and the second tip event are events for allowing skills to be possessed or obtained. Furthermore, the first ability event and the second ability event are events for increasing or decreasing the ability parameters of the nurture-target character. The aptitude event is an event for increasing or decreasing the aptitude parameters of the nurture-target character. The story event is an event for displaying a story related to a character appearing in the nurture game. Note that there is a story event for changing the ability parameters or the aptitude parameters in addition to displaying a story.

Here, the scenario event includes a first tip event, a second tip event, a first ability event, a second ability event, an aptitude event, and a story event. Furthermore, the dedicated events and the support events include a first tip event, a second tip event, a first ability event, and a second ability event. Note that the dedicated events may include a story event.

In this embodiment, in addition to processing for determining a scenario event and processing for determining a dedicated event(s), the turn start-time processing includes “processing for determining the occurrence or not of a first event”, “processing for determining the arrangement or not of a support character”, “processing for determining increase values for ability parameters”, “processing for determining a performance parameter”, “processing for determining a second event”, and “processing for determining a live cooperation member” that are shown in FIG. 28. Note that, although various processing procedures are executed in the turn start-time processing in addition to these processing procedures, the processing procedures shown in FIG. 28 will be sequentially described here.

### <Processing for Determining Occurrence or not of First Event>

A first event is selected by a lottery from among the support events (first events) linked to the support cards registered by the player in the preparatory-stage processing. Specifically, at the start of a turn, a random number is randomly acquired, and the occurrence or not of a first event and the content of the first event are determined on the basis of the acquired random number and the first-event table. In the first-event table, a selection ratio of “making a first event occur” and “not making a first event occur” is set. In this embodiment, the first event includes four types of events, i.e., an event a, an event b, an event c, and an event d. For example, in the first-event table, the rate of “making each of the events (events a to d) occur” is set to 20%, and the rate of “not making a first event occur” is set to 20%. Note that the selection ratio for a first event may be individually set for each support card, that is, each support character.

### <Processing for Determining Arrangement or not of Support Character>

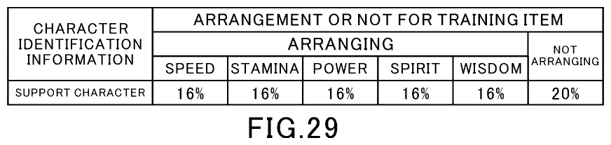

FIG. 29 is a view for explaining an arrangement-or-not table. As shown in FIG. 29, a selection ratio of arranging or not of a support character for a training item (“arranging for any of the training items” and “not arranging”) is set in the arrangement-or-not table. In this embodiment, the arrangement or not of each of the support characters corresponding to all the support cards registered by the player in the preparatory-stage processing is determined on the basis of the arrangement-or-not table shown in FIG. 29. Specifically, at the start of a turn, a random number is randomly acquired, and the arrangement or not of each of the support characters for a training item is determined on the basis of the acquired random number and the arrangement-or-not table. However, the present invention is not limited thereto, and the arrangement or not of each of the support characters for a training item may also be selected by a lottery from among all support characters corresponding to all support cards implemented in the game.

Specifically, as shown in FIG. 29, in this embodiment, “arranging” of each support character for any of the training items of speed, stamina, power, spirit, and wisdom is selected at a rate of 16%, and “not arranging” of the support character for any of the training items is selected at a rate of 20%. Note that, as shown in FIG. 17A, a plurality of kinds of training of expertise are set for the support characters. Thus, for example, the selection ratio of arranging a support character for each training item may be set such that the selection ratio for the training item corresponding to the training of expertise is higher than that for training items not corresponding to the training of expertise. In the case where a lottery is performed, a lottery table in which a selection ratio used in the lottery is set may be stored in advance or the lottery table may be generated every time a lottery is performed.

Note that, after a training item for which a support character is to be arranged is determined, the support character determined to be arranged and the determined training item may be linked to each other and may be stored in the server 1000. More specifically, it is possible to store, in the server 1000, link information that links the training ID indicating the type of the training item to the character ID of the support character or the support card ID of the support card linked to the support character.

### <Processing for Determining Increase Values for Ability Parameters>

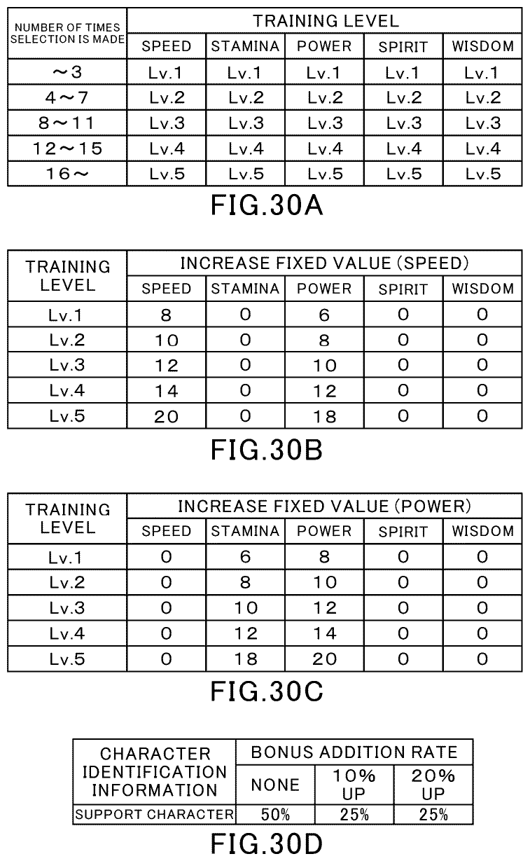

FIG. 30A is a view for explaining a training-level table. As shown in FIG. 30A, the training level is set so as to be raised according to the number of times to select each training. Specifically, in the case where the number of times to select each training is three times or less, the training level of the corresponding one of speed, stamina, power, spirit, and wisdom is set to “level 1”. In the case where the number of times to select each training is equal to or greater than 4 times and is equal to or less than 7 times, the training level thereof is set to “level 2”. In the case where the number of times to select each training is equal to or greater than 8 times and is equal to or less than 11 times, the training level thereof is set to “level 3”. In the case where the number of times to select each training is equal to or greater than 12 times and is equal to or less than 15 times, the training level thereof is set to “level 4”. In the case where the number of times to select each training is equal to or greater than 16 times, the training level thereof is set to “level 5”.

In this embodiment, in the case where training selected by the player is executed successfully, the values of predetermined ability parameters are increased due to the executed training item.

Specifically, in this embodiment, in the case where training of speed is executed successfully, the values of the ability parameters of speed and power are increased.

Furthermore, in the case where training of stamina is executed successfully, the values of the ability parameters of stamina and spirit are increased.

Furthermore, in the case where training of power is executed successfully, the values of the ability parameters of stamina and power are increased.

Furthermore, in the case where training of spirit is executed successfully, the values of the ability parameters of speed, power, and spirit are increased.

Furthermore, in the case where training of wisdom is executed successfully, the values of the ability parameters of speed and wisdom are increased.

In this embodiment, the value of an ability parameter to be increased in the case where training is successful is calculated by adding, to the increase fixed value, which is determined in accordance with the executed training item and the training level, a value that is obtained by multiplying the increase fixed value by a bonus addition rate to be described later.

FIG. 30B is a view for explaining an increase fixed value (speed) table. Furthermore, FIG. 30C is a view for explaining an increase fixed value table (power). That is, FIG. 30B shows increase fixed values in the case where the training item is speed. Furthermore, FIG. 30C shows increase fixed values in the case where the training item is power.

As shown in FIGS. 30B and 30C, the increase fixed values each determined in accordance with the executed training item and the training level are stored in the increase fixed value table. Furthermore, in this embodiment, as shown in FIGS. 30B and 30C, it is set that the ability parameters are more increased as the training level is higher.

Note that, although not shown here, increase fixed value tables to be used in the case where stamina, spirit, and wisdom are selected as training items are also provided.

Furthermore, in addition to the above-described increase fixed values, the bonus addition rate is determined on the basis of a support character that is arranged for each training item.

FIG. 30D is a view for explaining a bonus addition rate table. In this embodiment, the bonus addition rate is determined on the basis of a support character determined to be arranged for each training. Specifically, as shown in FIG. 30D, in the bonus addition rate table, a selection ratio of the presence/absence of a bonus addition rate and the addition rates (10% up and 20% up) is set for a support character.

For the bonus addition rate, “none” is selected at a rate of 50%, “10% up” is selected at a rate of 25%, and “20% up” is selected at a rate of 25%.

Then, the values obtained by multiplying the increase fixed values determined by the increase fixed value table by the bonus addition rate are derived as bonus additional values. The values obtained by adding the bonus additional values to the increase fixed values are determined as the amounts of increase in the values of the ability parameters when training is successful. Note that, for training for which a plurality of support characters are arranged, the bonus additional values for each of the arranged support characters are added to the increase fixed values. In this way, the amounts of increase in the ability parameters of the nurture-target character when training is successful are determined for all the training types.

### <Processing for Determining Performance Parameter>

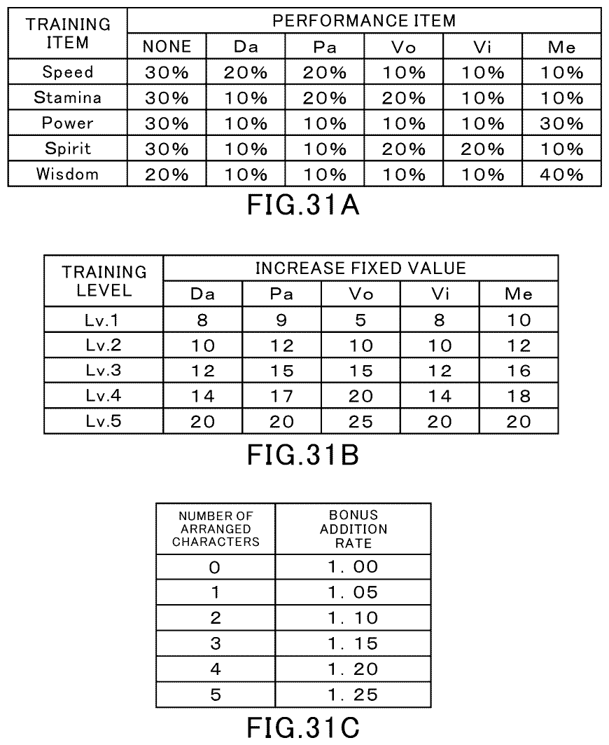

FIG. 31A is a view for explaining performance items linked to training items. In a turn in which training can be executed, at the start of the turn, whether to link a performance item(s) to each of the five training items, and the performance item to be linked are determined. Specifically, first, whether to link a performance item(s) to the training item of speed is determined by a lottery.

At this time, the rate of determining that no performance item is linked to the training item of speed (indicated by “none” in the figure) is set to 30%. Furthermore, the rates of linking the performance items of dance, passion, vocal, visual, and mental to the training item of speed are set to 20%, 20%, 10%, 10%, and 10%, respectively.

Furthermore, for example, the rate of determining that no performance item is linked to the training item of power is set to 30%. Furthermore, the rates of linking the performance items of dance, passion, vocal, visual, and mental to the training item of power are set to 10%, 10%, 10%, 10%, and 30%, respectively. Here, as shown in FIG. 31A, the rates of performance items being linked to training items are set in advance for the individual training items and for the individual performance items.

Note that, in this embodiment, up to two performance items can be linked to one training item in one turn. Therefore, for example, in the case where a performance item(s) to be linked to the training item of speed is determined, two lotteries are executed at the rates shown in FIG. 31A. In the case where the results of both the two lotteries show “none”, any of the performance items is not linked to the training item of speed.

Furthermore, for example, in the case where the results of the two lotteries are both dance, only the performance item of dance is linked to the training item of speed. Note that, in the case where any of the performance items is determined at the first lottery, the second lottery may be executed by excluding the performance item determined at the first lottery. In this case, the rates of determining the individual performance items may be changed at the first lottery and the second lottery.

Furthermore, here, in one turn, the same performance item could be linked to a plurality of training items. For example, the performance item of dance could be linked to both speed and stamina depending on the results of lotteries. However, it is also possible that the same performance item is not linked to a plurality of training items in one turn.

Furthermore, here, depending on each training item, the performance item(s) that has a high rate of being linked thereto and the performance items that have a low rate of being linked thereto are provided. For example, the performance items of dance and passion are linked to the training item of speed at higher rates than the other performance items.

Furthermore, depending on each performance item, the training item(s) that has a high rate of being linked and the training items that have a low rate of being linked are provided. For example, the performance item of mental is linked to the training items of power and wisdom at higher rates than to the other training items.

However, the rates of each performance item linked to the training items may be the same for all the training items. Furthermore, the rates of each training item to which the performance items are linked may be the same for all the performance items. In any of the cases, the rates shown in FIG. 31A are merely one examples. Furthermore, a method for determining the performance item(s) to be linked to any of the training items can be appropriately designed.

FIG. 31B is a view for explaining increase fixed values for the performance parameters. When a performance item(s) to be linked to a training item is determined, next, for each of the performance item(s) linked to the training item, the increase fixed value for the performance parameter is determined. The increase fixed values are set in advance for each performance item. Furthermore, the increase fixed values are set at individual training levels of the training item.

FIG. 31B shows the increase fixed values for the training item of speed. For example, it is assumed that the performance item of dance is linked to the training item of speed. In this case, the increase fixed value for the performance parameter of dance linked to the training item of speed is determined. At this time, if the training level of speed is level 1, the increase fixed value is determined to be 8, and, if the training level of speed is level 5, the increase fixed value is determined to be 20. As is clear from FIG. 31B, the increase fixed value is increased as the training level is higher.

Note that, here, it is assumed that the increase fixed values at the individual training levels are different for each training item. That is, the table shown in FIG. 31B is provided for each of the training items. However, the table shown in FIG. 31B may be the same for all the training items.

FIG. 31C is a view for explaining bonus addition rates for the performance parameters. When the increase fixed value(s) is determined as described above, a bonus addition rate is determined next. The bonus addition rate is different depending on the number of characters arranged for the training item to which the performance item(s) is linked. For example, it is assumed that the performance item of dance is linked to the training item of speed of which the training level is level 5. At this time, the increase fixed value for the performance parameter of dance is 20.

Then, in the case where no character is arranged for the training item of speed, the bonus addition rate is determined to be 1.00. Furthermore, in the case where one to five characters are arranged for the training item of speed, the bonus addition rates are determined to be 1.05 to 1.25 depending on the number of arranged characters, as shown in FIG. 31C. Here, the bonus addition rate is increased as the number of arranged characters is larger.

The increase value for a performance parameter is calculated by multiplying the increase fixed value by the bonus addition rate. For example, in the above-described example, if the number of characters arranged for the training item of speed is 0, the increase value for the performance parameter is calculated as in 20×1.00=20. Furthermore, if the number of characters arranged for the training item of speed is 5, the increase value for the performance parameter is calculated as in 20×1.25=25. The increase value for the performance parameter calculated in this way is displayed in the performance-parameter display section 221, as shown in FIG. 21A.

Note that the above-described calculation method for the increase values for the performance parameters is merely one example. For example, the increase values for the performance parameters may be determined by a lottery. Furthermore, the bonus addition rate is not indispensable. Furthermore, the bonus addition rate may be determined on the basis of another element instead of or in addition to the number of arranged characters.

### <Processing for Determining Occurrence or not of Second Event>

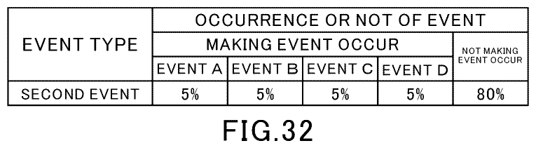

FIG. 32 is a view for explaining a second-event table. A second event is selected by a lottery from among the support events (second events) linked to the support card(s) corresponding to a support character(s) arranged for each training item. Specifically, after the “processing for determining the arrangement or not of a support character”, a random number is randomly acquired, and the occurrence or not of a second event is determined on the basis of the acquired random number and the second-event table. In the second-event table, a selection ratio of “making a second event occur” and “not making a second event occur” is set.

For example, as shown in FIG. 32, the second event includes four types of events, i.e., an event A, an event B, an event C, and an event D. For example, in the second-event table, the rate of “making each of the events (events A to D) occur” is set to 5%, and the rate of “not making a second event occur” is set to 80%. Note that the selection ratio for a second event may be individually set for each support card, that is, each support character.

In this embodiment, after the “processing for determining the arrangement or not of a support character”, the processing for determining the occurrence or not of a second event is performed for all support characters arranged for the individual training items. Then, the event notification display 247 is displayed in the training screen 240 on the basis of the determination on the occurrence of a second event. In the case where the player selects training for which a character with which the occurrence of a second event has been determined is arranged, the second event occurs after execution of the training.

For example, in the case where appearance of a second tip event of a support character that is arranged for training of speed has been determined, when the training of speed is executed, the second tip event surely appears after the execution of the training. However, when training other than speed is executed, this second tip event does not appear after the execution of the training. At this time, in the case where the occurrence of second events of two or more characters has been determined, which of the second events is made to occur is determined by a lottery or by the priorities set in advance for the support events.

For example, which of the plurality of second events is made to occur is determined with an equal probability. However, the present invention is not limited thereto, and it is also possible that weights are set according to the types of second events, and which of the plurality of second events is made to occur is determined according to the set weights. Note that, in the case where the occurrence of second events of two or more characters is determined, it is also possible that the determined second events are all made to occur.

Here, for example, after the appearance of a second event is determined, appearance information indicating the appearance or not of a support event may be linked to the support card or the support character linked to the second event and may be stored in the server 1000. More specifically, it is possible to store, in the server 1000, link information in which the appearance information is linked to the character ID of the support character or the support card ID of the support card linked to the support character.

### <Processing for Determining Live Cooperation Member>

As described above, a live cooperation member(s) is determined in a turn set in advance. Note that the method for determining a live cooperation member(s) is not particularly limited. For example, a character set in advance may be determined to be a live cooperation member, in each predetermined turn. Alternatively, a character that is to become a live cooperation member may be determined by a lottery in each predetermined turn. Furthermore, a character that is to become a live cooperation member may be determined by a lottery in every turn.

In the above-described nurture main game, the nurture game ends when all the turns end. Furthermore, during the nurture main game, in the case where a goal set for each character is not achieved, the nurture game ends at that point.

Here, when the nurture game ends, the nurture-target character nurtured in the nurture game is stored as a nurtured character. More specifically, information related to the nurtured character nurtured in the nurture game (hereinafter, referred to as nurtured-character information) is stored while being linked to the player ID. Note that the nurtured-character information is stored in both of the player terminal 1 and the server 1000. The nurtured-character information to be stored while being linked to the player ID includes the ability parameters, the aptitude parameters, the obtained skills, the inheritance information, etc.

Furthermore, when the nurture game ends, the evaluation points of the nurtured character, which has been nurtured, are calculated. Here, the evaluation points are calculated on the basis of the ability parameters, the aptitude parameters, the obtained skills, the results of races, etc., at the end of the nurture game. Note that a method for calculating the evaluation points, in other words, a formula for calculating the evaluation points, is prepared in advance, and the evaluation points are calculated on the basis of the predetermined formula. Note that the method or the formula for calculating the evaluation points is not particularly limited. For example, the evaluation points may be calculated on the basis of only the parameters, such as the ability parameters, the aptitude parameters, the obtained skills, etc., at the end of the nurture game, that affect a race result when the nurtured character participates in a race of a team competition game or another race game.

Furthermore, a nurture rank is set for the nurtured character on the basis of the evaluation points. The nurture rank is an index indicating the strength of the nurtured character, and the range of evaluation points is made to correspond to each nurture rank. For example, a nurture rank “A+” is given to a nurtured character of which the evaluation points fall within the range from 13000 to 14499, and a nurture rank “S” is given to a nurtured character of which the evaluation points fall within the range from 14500 to 15499. In this way, a nurture rank is given on the basis of the evaluation points, thus making it easy to understand the general strength of the nurtured character. Note that the nurtured-character information also includes the evaluation points and the nurture rank.

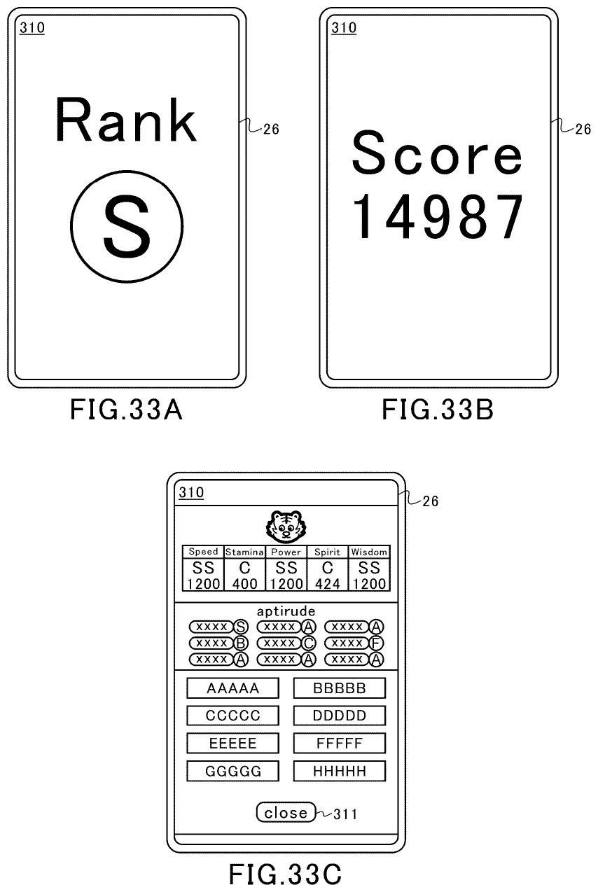

FIG. 33A is a first view for explaining a nurture complete screen 310. FIG. 33B is a second view for explaining the nurture complete screen 310. FIG. 33C is a third view for explaining the nurture complete screen 310. When the nurture game ends, the nurture complete screen 310 is displayed on the display 26, as shown in FIG. 33A. In the nurture complete screen 310, the nurture rank of the nurtured character, which has been nurtured, is first displayed, and then, the evaluation points thereof are displayed, as shown in FIG. 33B.

Furthermore, when a predetermined period of time has elapsed after the evaluation points are displayed, the ability parameters, the aptitude parameters, and the obtained skills of the nurtured character are displayed in the nurture complete screen 310, as shown in FIG. 33C. At this time, a close operation section 311 is provided in the nurture complete screen 310. When the close operation section 311 is tapped, the nurture complete screen 310 is hidden, and the home screen 100 is displayed on the display 26.

Note that, when the nurture game ends, a lottery for a factor to be obtained by the nurture-target character is performed, and factor information is stored while being linked to the nurtured character. Although not shown in the figures, the player can make the factor information that has been obtained by the nurtured character, displayed in the nurture complete screen 310.

As described above, in the nurture game, a nurtured character having the ability parameters, the aptitude parameters, the obtained skills, etc. is generated. In the nurture game, since the arrangement of a support character(s) and the occurrence of various events are determined by lotteries, even if an identical character is set to a nurture-target character, a nurtured character having different parameters is generated.

Next, functional configurations of the player terminal 1 and the server 1000 for executing the above-described nurture game will be described below.

### (Functional Configuration of Player Terminal 1)

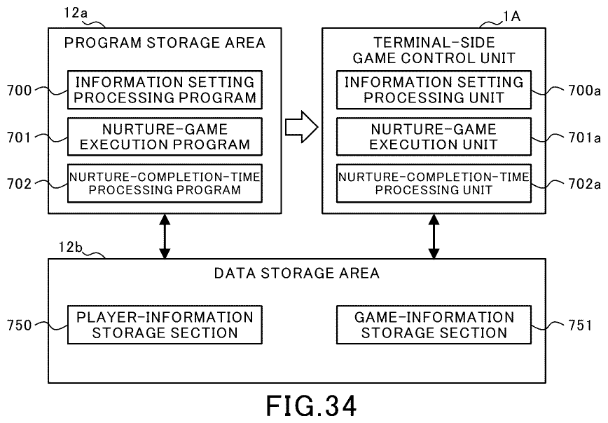

FIG. 34 is a view for explaining the configuration of the memory 12 at the player terminal 1 and the function of the player terminal 1 serving as a computer. In the memory 12, a program storage area 12a and a data storage area 12b are provided. When the game is started, the CPU 10 stores terminal-side game control programs (modules) in the program storage area 12a.

The terminal-side game control programs include an information setting processing program 700, a nurture-game execution program 701, and a nurture-completion-time processing program 702. Note that the programs listed in FIG. 34 are merely examples, and a large number of other programs are also provided as the terminal-side game control programs.

In the data storage area 12b, a player-information storage section 750 and a game-information storage section 751 are provided as storage sections for storing data. Note that a large number of other storage sections are also provided in the data storage area 12b. Here, information directly related to games such as a nurture game (hereinafter, referred to as game information) is stored in the game-information storage section 751.

Note that various kinds of information during the progress of games such as the nurture game are temporarily stored in the game-information storage section 751. Therefore, information related to a nurtured character that has been nurtured in the nurture game is all stored in the game-information storage section 751. Furthermore, for example, information other than the game information, such as information related to a player or another player, setting information of the player terminal 1, and information related to characters that can be set as a nurture-target character, is all referred to as player information. The player information is stored in the player-information storage section 750.

The CPU 10 runs the individual programs stored in the program storage area 12a and updates data in the individual storage sections of the data storage area 12b. Then, the CPU 10 runs the individual programs stored in the program storage area 12a, thereby causing the player terminal 1 (computer) to function as a terminal-side game control unit 1A. The terminal-side game control unit 1A includes an information setting processing unit 700a, a nurture-game execution unit 701a, and a nurture-completion-time processing unit 702a.

Specifically, the CPU 10 runs the information setting processing program 700, thereby causing the computer to function as the information setting processing unit 700a. Similarly, the CPU 10 runs the nurture-game execution program 701 and the nurture-completion-time processing program 702, thereby causing the computer to function as the nurture-game execution unit 701a and the nurture-completion-time processing unit 702a, respectively.

In the case where setting of various kinds of information is performed at the player terminal 1, the information setting processing unit 700a stores information related to the setting, as player information, in the player-information storage section 750. Furthermore, in the case where information in the player-information storage section 750 is updated, the information setting processing unit 700a sends the updated information to the server 1000.

The nurture-game execution unit 701a executes all processing procedures related to the nurture game. Specifically, the nurture-game execution unit 701a executes the preparatory-stage processing and the nurture-stage processing.

The nurture-completion-time processing unit 702a stores, at the time of completion of the nurture game, nurtured-character information including the ability parameters, the aptitude parameters, the obtained skills, the inheritance information, the factor information, and the types of characters used for nurture of the nurtured character.

### (Functional Configuration of Server 1000)

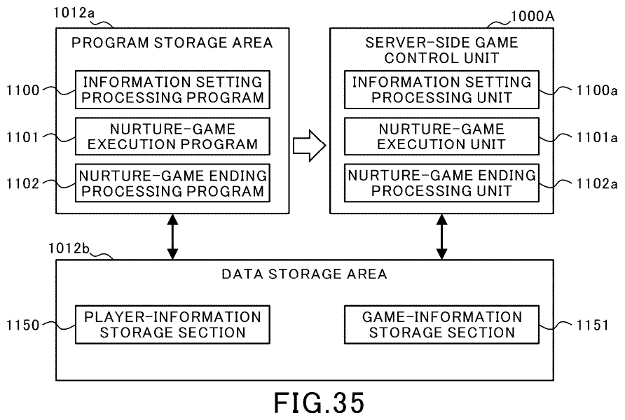

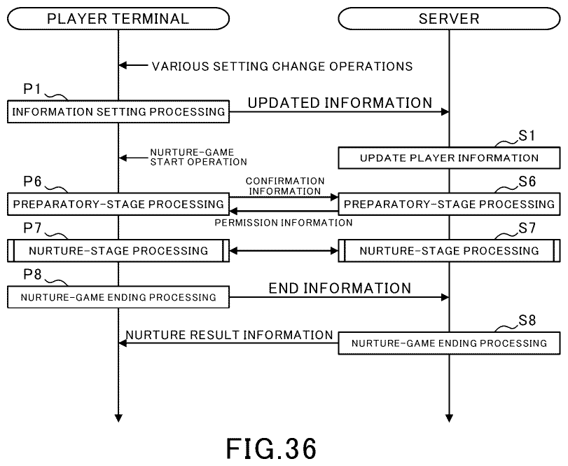

FIG. 35 is a view for explaining the configuration of the memory 1012 at the server 1000 and the function of the server 1000 serving as a computer. In the memory 1012, a program storage area 1012a and a data storage area 1012b are provided. When the game is started, the CPU 1010 stores server-side game control programs (modules) in the program storage area 1012a.

The server-side game control programs include an information setting processing program 1100, a nurture-game execution program 1101, and a nurture-game ending processing program 1102. Note that the programs listed in FIG. 35 are merely examples, and a large number of other programs are also provided as the server-side game control programs.

In the data storage area 1012b, a player-information storage section 1150 and a game-information storage section 1151 are provided as storage sections for storing data. Note that a large number of other storage sections are also provided in the data storage area 1012b. Here, pieces of game information of all players are stored in the game-information storage section 1151 while being linked to the player IDs thereof. Furthermore, pieces of player information of all players are stored in the player-information storage section 1150 while being linked to the player IDs thereof.

The CPU 1010 runs the individual programs stored in the program storage area 1012a and updates data in the individual storage sections of the data storage area 1012b. Then, the CPU 1010 runs the individual programs stored in the program storage area 1012a, thereby causing the server 1000 (computer) to function as a server-side game control unit 1000A. The server-side game control unit 1000A includes an information setting processing unit 1100a, a nurture-game execution unit 1101a, and a nurture-game ending processing unit 1102a.

Specifically, the CPU 1010 runs the information setting processing program 1100, thereby causing the computer to function as the information setting processing unit 1100a. Similarly, the CPU 1010 runs the nurture-game execution program 1101 and the nurture-game ending processing program 1102, thereby causing the computer to function as the nurture-game execution unit 1101a and the nurture-game ending processing unit 1102a, respectively.

In the case where various kinds of information are set at the player terminal 1, the information setting processing unit 1100a updates the player information in the player-information storage section 1150 on the basis of updated information received from the player terminal 1. Furthermore, the information setting processing unit 1100a measures time and updates the game points of each player.

The nurture-game execution unit 1101a executes all processing procedures related to the nurture game. Specifically, the nurture-game execution unit 1101a executes the preparatory-stage processing and the nurture-stage processing.

The nurture-game ending processing unit 1102a derives, when the nurture game ends, the evaluation points, the nurture rank, etc., of the nurtured character that has been nurtured. Furthermore, the nurture-game ending processing unit 1102a determines, by a lottery, a factor to be obtained by the nurtured character. Then, the nurture-game ending processing unit 1102a stores the nurtured-character information including the ability parameters, the aptitude parameters, the obtained skills, the inheritance information, the factor information, and the types of characters used for nurture of the nurtured character, in the game-information storage section 1151 while making it linked to the player ID.

Note that the information setting processing unit 700a in the player terminal 1 and the information setting processing unit 1100a in the server 1000 are common in that they store player information but are different from each other in terms of the content of specific processing and the range of player information to be stored. Furthermore, the nurture-game execution unit 701a and the nurture-game ending processing unit 702a in the player terminal 1 and the nurture-game execution unit 1101a and the nurture-game ending processing unit 1102a in the server 1000 are common in that they execute processing related to the nurture game but are different in terms of their roles, i.e., handling areas.

Processing procedures carried out by the above-described individual functional units in the player terminal 1 and the server 1000 will be described below with reference to flowcharts.

### (Processing at Player Terminal 1 and Server 1000)

### <Processing Related to Nurture Game>

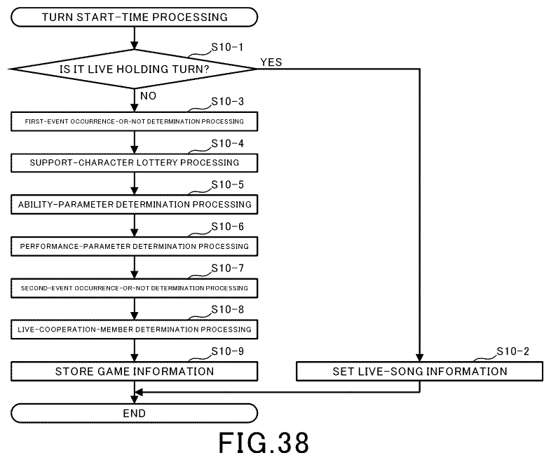

FIG. 38 is a sequence diagram for explaining processing procedures related to the nurture game and performed at the player terminal 1 and the server 1000. Note that, in the following description, processing at the player terminal 1 is indicated by Pn (n is an arbitrary integer). Furthermore, processing at the server 1000 is indicated by Sn (n is an arbitrary integer).

When the player performs various setting change operations at the player terminal 1, the information setting processing unit 700a of the player terminal 1 performs information setting processing (P1) for updating the player-information storage section 750 on the basis of the player's operation inputs. In this information setting processing, updated information is sent to the server 1000. At the server 1000, when the updated information is received, the information setting processing unit 1100a updates the player information in the player-information storage section 1150 (S1).

Note that the player information updated in P1 and S1 includes, for example, the profile information, which can be set by the player. Furthermore, for example, when an operation for adding another player as a friend or an operation for releasing a friend is input as a setting change operation, friend information that is information related to friends is updated. Note that, in P1 and S1, the information setting processing unit 700a and the information setting processing unit 1100a individually manage the game points to be consumed in order to execute the nurture game. In the case where the game points are less than the upper limit, the information setting processing units 700a and 1100a measure time and give game points to the player by a predetermined value at intervals of a predetermined period of time.

When a nurture-game start operation for starting the nurture game is input at the player terminal 1, the nurture-game execution unit 701a executes the preparatory-stage processing (P6). Furthermore, during the preparatory-stage processing, communication processing is performed between the player terminal 1 and the server 1000. At the server 1000, the nurture-game execution unit 1101a executes the preparatory-stage processing (S6) on the basis of information received from the player terminal 1.

When the preparatory-stage processing (P6) ends, the nurture-game execution unit 701a executes the nurture-stage processing (P7). Furthermore, during the nurture-stage processing, communication processing is performed between the player terminal 1 and the server 1000. At the server 1000, the nurture-game execution unit 1101a executes the nurture-stage processing (S7) on the basis of information received from the player terminal 1. Note that, actually, the player terminal 1 and the server 1000 share roles, to proceed with the nurture main game through the nurture-stage processing (P7) at the player terminal 1 and the nurture-stage processing (S7) at the server 1000. However, a portion or the entirety of processing procedures, to be described below, in the nurture-stage processing (P7) at the player terminal 1 may be carried out in the nurture-stage processing (S7) at the server 1000, or a portion or the entirety of processing procedures in the nurture-stage processing (S7) at the server 1000 may be carried out in the nurture-stage processing (P7) at the player terminal 1.

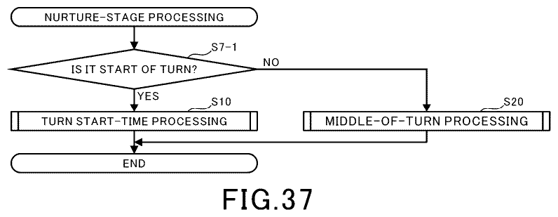

FIG. 37 is a flowchart for explaining the nurture-stage processing at the server 1000. The nurture-game execution unit 1101a of the server 1000 executes turn start-time processing (S10) if it is the start of a turn (YES in S7-1). Furthermore, the nurture-game execution unit 1101a executes middle-of-turn processing (S20) after the turn start-time processing is executed.

FIG. 38 is a flowchart for explaining the turn start-time processing at the server 1000. The nurture-game execution unit 1101a of the server 1000 determines whether the current turn is a live holding turn (S10-1). If the current turn is a live holding turn (YES in S10-1), the nurture-game execution unit 1101a sets live-song information (S10-2). Note that, when the player obtains a live song or the like, information indicating the obtained live song or the like is stored as live-song information in the player terminal 1 and the server 1000. Here, live-song information about live songs or the like that have been obtained from the start of the nurture game or the last live holding turn to the current turn is extracted and is set so as to be received by the player terminal 1.

Furthermore, if the current turn is not a live holding turn (NO in S10-1), the nurture-game execution unit 1101a executes first-event occurrence-or-not determination processing (S10-3). Specifically, at the start of a turn, a random number is randomly acquired, and the occurrence or not of a first event and the content of the first event are determined on the basis of the acquired random number and the first-event table.

Next, the nurture-game execution unit 1101a executes support-character lottery processing (S10-4). Specifically, the nurture-game execution unit 1101a refers to the arrangement-or-not table shown in FIG. 29, and determines, by a lottery, whether a support character is arranged for each training item. This processing is executed for each support character. Note that, in the case where arrangement of a support character for a training item has been determined, the nurture-game execution unit 1101a links the support character ID to the training ID corresponding to the training item.

Furthermore, here, it is also possible to further execute a lottery as to whether a support character linked to a support card that is not registered in the deck by the player is arranged for a training item. Furthermore, it is also possible to execute a lottery as to whether a predetermined character that appears in the nurture game and that is different from support characters is arranged for a training item.

Next, the nurture-game execution unit 1101a executes ability-parameter determination processing (S10-5). In the ability-parameter determination processing, increase values for the ability parameters of the nurture-target character when each training is executed successfully are determined. Specifically, the nurture-game execution unit 1101a determines, for each of the training items, increase values for the ability parameters of the nurture-target character in the case where the corresponding training is successful, by referring to the training-level table, which is shown in FIG. 30A, the increase fixed value tables, which are shown in FIGS. 30B and 30C, and the bonus addition rate table, which is shown in FIG. 30D. Furthermore, the nurture-game execution unit 1101a determines a physical-strength reduction amount or a physical-strength restoration amount in the case where each training item is executed, by referring to a physical strength table (not shown). Furthermore, the nurture-game execution unit 1101a calculates a training failure rate for each training item on the basis of the physical strength of the nurture-target character.

Next, the nurture-game execution unit 1101a executes performance-parameter determination processing (S10-6). In the performance-parameter determination processing, a performance item(s) to be linked to each training is determined. Specifically, the nurture-game execution unit 1101a executes a lottery as to whether to link a performance item(s) to a training item at a rate(s) shown in FIG. 31A. This lottery is executed for each training item. Then, zero to two performance items are linked to one training item.

Furthermore, the nurture-game execution unit 1101a determines an increase value(s) for the performance parameter(s) in the case where each training is executed successfully. Specifically, the nurture-game execution unit 1101a determines an increase value(s) for the performance parameter(s) linked to the training item on the basis of an increase fixed value table (see FIG. 31B) and a bonus addition rate table (see FIG. 31C).

Next, the nurture-game execution unit 1101a executes second-event occurrence-or-not determination processing (S10-7). Specifically, the nurture-game execution unit 1101a determines, by a lottery, the occurrence or not of a second event by referring to the second-event table, which is shown in FIG. 32. Specifically, the nurture-game execution unit 1101a randomly acquires a random number and determines the occurrence or not of a second event on the basis of the acquired random number and the second-event table. Here, for example, the nurture-game execution unit 1101a determines, by a lottery, whether to execute a support event that is set in advance for the support card linked to each training item.

Furthermore, the nurture-game execution unit 1101a executes live-cooperation-member determination processing (S10-8). Here, in the case where the current turn is a turn set in advance, a live cooperation member is determined according to a predetermined algorithm.

Then, the nurture-game execution unit 1101a stores game information including information related to the lottery results in S10-3 to S10-8, in the game-information storage section 1151 such that the player terminal 1 can receive the game information (S10-9).

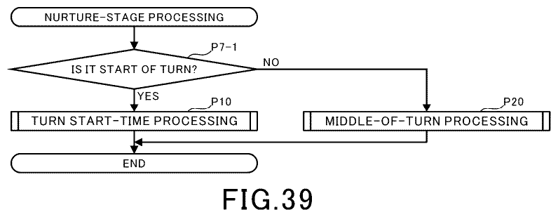

FIG. 39 is a flowchart for explaining the nurture-stage processing at the player terminal 1. The nurture-game execution unit 701a of the player terminal 1 executes turn start-time processing (P10) if it is the start of a turn (YES in P7-1) and executes middle-of-turn processing (P20) if it is not the start of a turn.

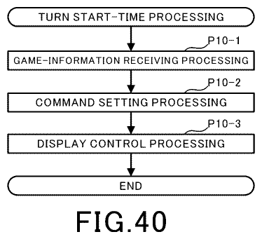

FIG. 40 is a flowchart for explaining the turn start-time processing at the player terminal 1. At the start of a turn, the nurture-game execution unit 701a accesses the game-information storage section 1151 of the server 1000 and receives, from the server 1000, the game information stored in S10-9 (P10-1).

Then, the nurture-game execution unit 701a executes command setting processing for enabling the player to select various commands related to the nurture-stage processing (P10-2). Specifically, the nurture-game execution unit 701a performs processing for enabling the player to select various commands, such as the rest operation section 215, the training operation section 216, the skill operation section 217, the going-out operation section 218, the race operation section (specific command) 219, the live-preparation operation section 220, etc., on the basis of the current turn number, as shown in FIG. 19, for example. Furthermore, the nurture-game execution unit 701a performs processing for enabling the player to select a plurality of race selection operation sections (subcommands) 261 linked to the race operation section 219.

Furthermore, in the command setting processing, the nurture-game execution unit 701a enables the player to select the commands of the speed operation section 241, the stamina operation section 242, the power operation section 243, the spirit operation section 244, and the wisdom operation section 245, which correspond to the individual training items. The nurture-game execution unit 701a performs processing for enabling the player to select one command from among the plurality of commands.

Note that, in a live holding turn, the nurture-game execution unit 701a makes the live-preparation operation section 220 and the live start button 300a selectable and makes the other operation sections, i.e., commands, not selectable.

Next, the nurture-game execution unit 701a executes display control processing for displaying the game screen 210, the training screen 240, the live start screen 300, etc., on the basis of the game information received from the server 1000, the current turn, and the result of the command setting processing in P10-2 (P10-3). Accordingly, thereafter, at the player terminal 1, it is determined that it is the middle of the turn, and the middle-of-turn processing (P20) for accepting an operation input of the player is executed.

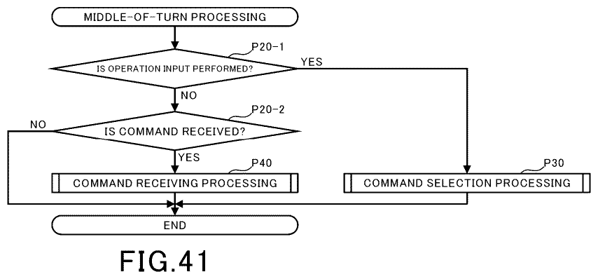

FIG. 41 is a flowchart for explaining the middle-of-turn processing at the player terminal 1. When an operation input of the player is performed at the player terminal 1 (YES in P20-1), the nurture-game execution unit 701a executes command selection processing (P30). Furthermore, in the case where an operation input is not performed (NO in P20-1), and a command is received from the server 1000 (YES in P20-2), the nurture-game execution unit 701a executes command receiving processing (P40).

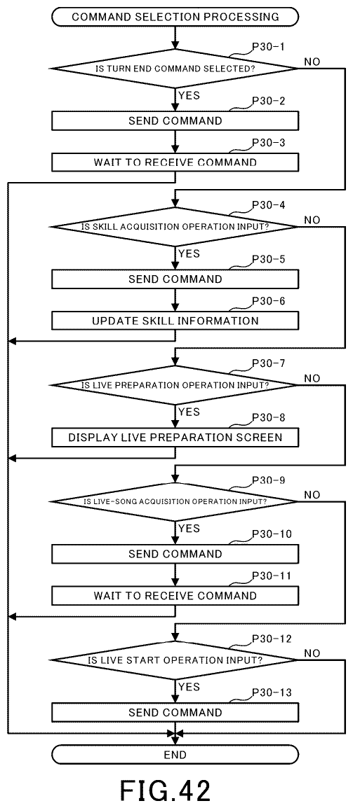

FIG. 42 is a flowchart for explaining the command selection processing at the player terminal 1. When any of turn end commands (the rest operation section 215, the going-out operation section 218, the speed operation section 241, the stamina operation section 242, the power operation section 243, the spirit operation section 244, the wisdom operation section 245, and the race operation section 274) that are predetermined commands for ending the turn is selected by the player (YES in P30-1), the nurture-game execution unit 701a sends the selected command to the server 1000 (P30-2) Then, the nurture-game execution unit 701a waits to receive a command from the server 1000 (P30-3).

Furthermore, when a skill acquisition operation for obtaining a skill (a tap on any of the skill display fields 251) is input (YES in P30-4), the nurture-game execution unit 701a sends, to the server 1000, the command corresponding to the skill display field 251 on which the operation input has been performed (P30-5). Furthermore, the nurture-game execution unit 701a updates skill information indicating that the corresponding skill has been obtained (P30-6).

Furthermore, when a live preparation operation (a tap on the live-preparation operation section 220 or any of the live-song detail display fields 292) is input (YES in P30-7), the nurture-game execution unit 701a displays the live preparation screen 290 or the confirmation dialog 294 on the display 26 (P30-8).

Furthermore, when a live-song acquisition operation (a tap on the execution button 294a) is input (YES in P30-9), the nurture-game execution unit 701a sends, to the server 1000, the command corresponding to the live-song detail display field 292 on which the operation input has been performed (P30-10). Then, the nurture-game execution unit 701a waits to receive a command from the server 1000 (P30-11).

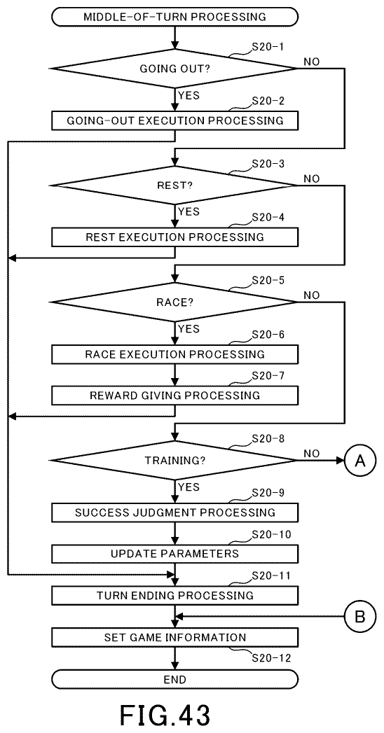

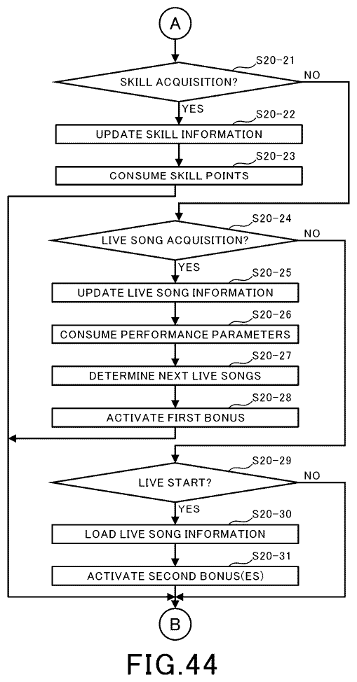

Furthermore, when a live start operation (a tap on the live start button 300a) is input (YES in P30-12), the nurture-game execution unit 701a sends, to the server 1000, a command indicating that the live start operation has been performed (P30-13). At the server 1000, when the command sent in the above-described step P30-2, P30-5, P30-10, or P30-13 is received, the middle-of-turn processing (S20) is executed, as shown in FIGS. 43 and 44.

FIG. 43 is a first flowchart for explaining the middle-of-turn processing at the server 1000. FIG. 44 is a second flowchart for explaining the middle-of-turn processing at the server 1000. When a command indicating an operation input of the going-out operation section 218 is received (YES in S20-1), the nurture-game execution unit 1101a performs going-out execution processing (S20-2). Here, a going-out event for increasing the parameters of the physical strength and the physical condition is determined. Furthermore, the parameters of the physical strength and the physical condition are updated on the basis of the determined going-out event.

When a command indicating an operation input of the rest operation section 215 is received (YES in S20-3), the nurture-game execution unit 1101a performs rest execution processing (S20-4). Here, a rest event for increasing the parameter of the physical strength is determined. Furthermore, the parameter of the physical strength is updated on the basis of the determined rest event.

When a command indicating an operation input for starting a race is received (YES in S20-5), the nurture-game execution unit 1101a performs race execution processing (S20-6). Here, a race simulation is executed on the basis of the parameters of the NPCs and the nurture-target character, which participate in the race. Furthermore, the nurture-game execution unit 1101a executes reward giving processing for giving rewards to the player (S20-7). Here, rewards are determined on the basis of the result of the simulation, i.e., the order of arrival, the race development, etc., of the nurture-target character, and the determined rewards are given to the player.

When a command indicating execution of any of the trainings is received (YES in S20-8), the nurture-game execution unit 1101a performs success judgment processing (S20-9). Here, whether the training is successful or not is judged on the basis of the failure rate, which is calculated in advance. Then, the nurture-game execution unit 1101a updates various parameters on the basis of the judgement result in S20-9 (S20-10). Note that, here, the ability parameter(s) etc. is updated as determined in S10-5 at the start of training. Furthermore, here, the performance parameter(s) is updated as determined in S10-6 at the start of training.

Then, in the case where any of the commands and processing that involve ending of the turn are executed (S20-2, S20-4, S20-6, S20-7, S20-9, S20-10), the nurture-game execution unit 1101a ends the current turn and performs processing for making a transition to the next turn (S20-11). Accordingly, at the server 1000, the middle-of-turn processing (S20) ends, and the server 1000 goes into a standby state for the turn start-time processing (S10).

Furthermore, various kinds of game information determined and updated in the various processing procedures shown in FIGS. 43 and 44 are set in the game-information storage section 1151 (S20-12). Here, the set game information is received by the player terminal 1.

Furthermore, as shown in FIG. 44, when a command indicating an input of the skill acquisition operation is received (YES in S20-21), the nurture-game execution unit 1101a updates the skill information in the game-information storage section 1151 (S20-22). Furthermore, the nurture-game execution unit 1101a consumes the skill points due to the acquisition of the skill (S20-23).

Furthermore, when a command indicating acquisition of a live song or the like is received (YES in S20-24), the nurture-game execution unit 1101a updates the live-song information indicating the obtained live song(s) or the like (S20-25). Furthermore, the nurture-game execution unit 1101a consumes the performance parameters due to the acquisition of the live song or the like (S20-26).

Furthermore, the nurture-game execution unit 1101a refers to the live-song route information to determine three live songs or the like that can be next selected by the player, on the basis of the obtained live song or the like (S20-27).

Furthermore, the nurture-game execution unit 1101a activates a first bonus linked to the obtained live song or the like (S20-28). Here, when the first bonus is activated, the ability parameters are increased, the physical strength is restored, and a skill tip is obtained. In this way, the first bonus linked to the live song or the like is activated in the turn in which the live song or the like is obtained.

Furthermore, when a command indicating the live start operation is received (YES in S20-29), the nurture-game execution unit 1101a loads live-song information indicating the live song(s) or the like obtained by the player (S20-30). Then, the nurture-game execution unit 1101a activates a second bonus(es) linked to the live song(s) or the like obtained from the start of the nurture main game or the last live holding turn to the current turn (live holding turn) (S20-31). Here, through activation of the second bonus(es), various parameters, such as the rate of training of expertise, the event occurrence rate, the skill tip occurrence rate, the race bonus, the failure rate, etc., are updated. In this way, the second bonus(es) linked to the live song(s) or the like is activated in a turn in which the first live holding event is executed after the live song(s) or the like has been obtained.

Note that, here, the benefits brought by the second bonus(es) continue after activation of the second bonus(es) until the nurture main game ends. However, the benefits brought by the second bonus(es) may also be valid only for a predetermined period. For example, the benefits brought by the second bonus(es) may continue after activation of the second bonus(es) until the next live holding turn or only until a preset number of turns elapses.

Then, at the player terminal 1, when the game information (command) set in S20-12 is received, the command receiving processing (P40) is executed in the middle-of-turn processing (P20), which is shown in FIG. 41.

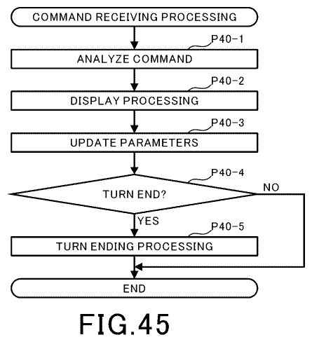

FIG. 45 is a flowchart for explaining the command receiving processing at the player terminal 1. The nurture-game execution unit 701a analyzes a command received from the server 1000 (P40-1). Then, the nurture-game execution unit 701a performs nurture-main-game-screen display processing for displaying various event screens, on the basis of the received command (P40-2).

Note that, in a live holding turn, the number of characters and the type(s) of the character(s) to be displayed on the live event screen 301 are determined in accordance with the number of live songs or the like and the live cooperation member(s). That is, in the live holding turn, the display pattern of the live event screen 301 is determined in accordance with the number of live songs or the like and the live cooperation member(s). Then, the nurture-game execution unit 701a displays the live event screen 301 in the determined display pattern. Note that, here, the display pattern of the live event screen 301 is determined at the player terminal 1. However, the display pattern of the live event screen 301 may be determined at the server 1000.

Furthermore, the nurture-game execution unit 701a updates various parameters in the game-information storage section 751 on the basis of the received command (P40-3). Then, in the case where a command for ending the turn is received (YES in P40-4), the nurture-game execution unit 701a executes turn ending processing (P40-5). Here, after display of various screens, such as an event screen, ends, processing for ending the current turn and starting the next turn is performed.

Although one aspect of the embodiment has been described above while referring to the accompanying drawings, it is needless to say that the present invention is not limited to the above-described embodiment. It is obvious that a person skilled in the art could think of various alternative embodiments or modifications within the range of the idea of the claims, and the alternative embodiments and modifications can be understood as certainly falling within the technical scope of the present invention.

The game properties and the processing procedures executed at the player terminal 1 and the server 1000 described in the above-described embodiment are merely examples. In any case, the information processing program just needs to make the computer (in the embodiment, one or both of the player terminal 1 and the server 1000) carry out the nurture game including a plurality of turns and to further make the computer carry out the following processing procedures.

### (Processing Made to be Carried Out by Computer)

Processing (as an example, P10-2 in the embodiment) for enabling the player to select a plurality of commands, including at least a first type command (as an example, execution of training in the embodiment) and a second type command (as an example, acquisition of a live song or the like in the embodiment), in a preset turn.

Processing (as an example, S20-10 in the embodiment) for obtaining a predetermined parameter (as an example, the performance parameter in the embodiment) on the basis of the fact that the first type command has been selected.

Processing (as an example, P30-8 in the embodiment) for enabling the player to obtain at least a part of a plurality of rewards (as an example, live songs or the like or bonuses linked to the live songs or the like in the embodiment) that bring benefits advantageous to the player, by consuming the predetermined parameter (as an example, S20-26 in the embodiment), on the basis of the fact that the second type command has been selected.

Processing (as an example, S20-27 in the embodiment) for determining a plurality of rewards that can be newly obtained by the player, on the basis of the fact that the reward has been obtained by the player.

Processing (as an example, S20-28, S20-31 in the embodiment) for making benefits that correspond to the reward obtained by the player, occur at a predetermined timing. Processing (as an example, S20-11, P40-5 in the embodiment) for ending the currently executed turn and making a transition to the next turn, when a preset turn end condition including at least that the first type command has been selected is established.

Note that, in the above-described embodiment, the number of turns in the nurture main game and the commands that can be selected by the player in each turn are merely examples. Furthermore, the game properties described in the above-described embodiment are merely examples. In any cases, the nurture game just needs to include a plurality of turns, and the game properties are not particularly limited.

Furthermore, in the above-described embodiment, a live song or the like is provided as a reward. However, the reward is not limited to a live song or the like. For example, the player can also obtain, as a reward, a first bonus or a second bonus itself in the above-described embodiment.

Furthermore, in the above-described embodiment, one turn ends through execution of a command for ending the turn. However, the turn end condition for ending one turn is not limited thereto. For example, in addition to the above-described embodiment, one turn may also end in the case where a live song or the like is obtained. Furthermore, for example, in addition to the above-described embodiment, it is also possible that a time limit is set for one turn, and the turn ends when the time limit elapses. In any cases, when the preset turn end condition including at least that the first type command has been selected is established, the currently executed turn is ended to make a transition to the next turn.

Furthermore, the benefits (as an example, the bonuses linked to a live song or the like in the embodiment) may include: a first benefit (as an example, the first bonus in the embodiment) that occurs in the turn in which the player obtains; and a second benefit (as an example, the second bonus in the embodiment) that occurs in a preset particular turn (as an example, the next live holding turn in the embodiment) after the turn in which the player obtains.

Note that, in the above-described embodiment, only the first bonus or only the second bonus may be linked to a live song or the like. In any cases, the benefit(s) corresponding to the reward obtained by the player just needs to occur at a predetermined timing(s), and the occurrence timing(s) is not particularly limited.

Furthermore, in the processing for enabling the player to obtain any of the plurality of rewards, the plurality of rewards that can be obtained by the player may be individually displayed in reward display fields (as an example, the live preparation screen 290 in the embodiment) in an identifiable manner. Furthermore, the reward display fields may each include a first display region (as an example, the first-bonus display field 292b in the embodiment) in which the first benefit is displayed and a second display region (as an example, the second-bonus display field 292c in the embodiment) in which the second benefit is displayed.

However, the live preparation screen 290 is merely an example. For example, in the above-described embodiment, only the titles of live songs or the like that can be obtained by the player may be displayed in the live preparation screen 290. In this case, the first bonus and the second bonus linked to each of the live songs or the like may be kept secret to the player without being notified thereto.

Note that, in the above-described embodiment, the bonuses linked to a live song or the like are classified into the first bonus and the second bonus. Then, in the above-described embodiment, the bonus that brings a benefit in the turn in which the live song or the like is obtained is classified into the first bonus, and the bonus that brings a benefit in the next live holding turn is classified into the second bonus.

That is, in the above-described embodiment, the bonuses are classified depending on the timings at which the benefits occur. However, the bonus classification method is not limited thereto. For example, a bonus for increasing the ability parameters may be classified into the first bonus, and the other bonus may be classified into the second bonus. Specifically, the bonuses may be classified depending on the content of benefits that occur. Even in this case, as in the above-described embodiment, the live preparation screen 290 is displayed such that classification of the bonuses can be identified.

In any cases, the benefits are classified into the first benefit and the second benefit, and, in the processing for enabling the player to obtain any of the plurality of rewards, the plurality of rewards that can be obtained by the player may be individually displayed in the reward display fields in an identifiable manner. At this time, the reward display fields may each include the first display region in which the first benefit is displayed and the second display region in which the second benefit is displayed.

Furthermore, in the processing for determining a plurality of rewards that can be newly obtained by the player, the plurality of rewards that can be newly obtained by the player may be determined on the basis of reward route information (as an example, live-song route information in the embodiment) in which relations between the reward obtained by the player and the plurality of rewards that can be newly obtained by the player are defined in advance. Furthermore, in the processing for determining a plurality of rewards that can be newly obtained by the player, the plurality of rewards that can be newly obtained by the player may be determined by a lottery. That is, the method for determining a plurality of rewards that can be newly obtained by the player is not particularly limited.

Note that the information processing program for executing the processing procedures in the above-described embodiment and various modifications may be stored in a non-transitory computer-readable storage medium and may be provided in the form of the storage medium. Alternatively, a game terminal device that includes this storage medium may be provided. Furthermore, the above-described embodiment and various modifications may be provided in the form of an information processing method for realizing the individual functions and the steps shown in the flowcharts.

What is claimed is:

1. A non-transitory computer readable medium storing a program causing a computer to carry out a nurture game that includes a plurality of turns, the program causing the computer to carry out:
processing for enabling a player to select a plurality of commands including at least a first type command and a second type command, in a preset turn of the plurality of turns;
processing for obtaining a predetermined parameter on the basis of the fact that the first type command has been selected;
processing for enabling the player to obtain at least a part of a plurality of rewards that bring benefits advantageous to the player, by consuming the predetermined parameter, on the basis of the fact that the second type command has been selected;
processing for determining a plurality of rewards that can be newly obtained by the player, on the basis of the fact that said reward has been obtained by the player;
processing for making one or more benefits that correspond to said reward obtained by the player, occur at a predetermined timing; and
processing for ending the currently executed turn and making a transition to a next turn, when a preset turn end condition including at least that the first type command has been selected is established.

2. The non-transitory computer readable medium according to claim 1, wherein the benefits include:
a first benefit that occurs in the turn in which the player obtains; and
a second benefit that occurs in a preset particular turn after the turn in which the player obtains.

3. The non-transitory computer readable medium according to claim 2,
wherein, in the processing for enabling the player to obtain said reward, the plurality of rewards that can be obtained by the player are individually displayed in detail display fields in an identifiable manner, and
wherein the detail display fields each include a first display region in which the first benefit is displayed and a second display region in which the second benefit is displayed.

4. The non-transitory computer readable medium according to claim 1,
wherein the benefits are classified into a first benefit and a second benefit,
wherein, in the processing for enabling the player to obtain said reward, the plurality of rewards that can be obtained by the player are individually displayed in detail display fields in an identifiable manner, and
wherein the detail display fields each include a first display region in which the first benefit is displayed and a second display region in which the second benefit is displayed.

5. The non-transitory computer readable medium according to claim 1, wherein, in the processing for determining the plurality of rewards that can be newly obtained by the player, the plurality of rewards that can be newly obtained by the player are determined on the basis of reward route information in which relations between said reward obtained by the player and the plurality of rewards that can be newly obtained by the player are defined in advance.

6. The non-transitory computer readable medium according to claim 1, wherein, in the processing for determining the plurality of rewards that can be newly obtained by the player, the plurality of rewards that can be newly obtained by the player are determined by a lottery.

7. An information processing method in which one or a plurality of computers carry out a nurture game including a plurality of turns, the one or the plurality of computers carrying out:
processing for enabling a player to select a plurality of commands including at least a first type command and a second type command, in a preset turn of the plurality of turns;
processing for obtaining a predetermined parameter on the basis of the fact that the first type command has been selected;
processing for enabling the player to obtain at least a part of a plurality of rewards that bring benefits advantageous to the player, by consuming the predetermined parameter, on the basis of the fact that the second type command has been selected;
processing for determining a plurality of rewards that can be newly obtained by the player, on the basis of the fact that said reward has been obtained by the player;
processing for making one or more benefits that correspond to said reward obtained by the player, occur at a predetermined timing; and
processing for ending the currently executed turn and making a transition to a next turn, when a preset turn end condition including at least that the first type command has been selected is established.

8. A game device that includes one or a plurality of computers carrying out a nurture game including a plurality of turns, the one or the plurality of computers carrying out:
processing for enabling a player to select a plurality of commands including at least a first type command and a second type command, in a preset turn of the plurality of turns;
processing for obtaining a predetermined parameter on the basis of the fact that the first type command has been selected;
processing for enabling the player to obtain at least a part of a plurality of rewards that bring benefits advantageous to the player, by consuming the predetermined parameter, on the basis of the fact that the second type command has been selected;
processing for determining a plurality of rewards that can be newly obtained by the player, on the basis of the fact that said reward has been obtained by the player;
processing for making one or more benefits that correspond to said reward obtained by the player, occur at a predetermined timing; and
processing for ending the currently executed turn and making a transition to a next turn, when a preset turn end condition including at least that the first type command has been selected is established.
